(19) United States
(12) Patent Application Publication
(10) Pub. No.: US 2025/0002267 A1
(43) Pub. Date: Jan. 2, 2025

(54) DELIVERY DEVICE

(71) Applicant: Rotolatch, LLC, Dallas, TX (US)

(72) Inventor: Javier E. Oliver, Dallas, TX (US)

(21) Appl. No.: 18/704,725

(22) PCT Filed: Oct. 27, 2022
(86) PCT No.: PCT/US2022/048052

§ 371 Date: Apr. 25, 2024

Related U.S. Application Data
(60) Provisional application No. 63/272,572, filed on Oct. 27, 2021.
(60) Provisional application No. 63/307,466, filed on Feb. 7, 2022.

(51) Int. Cl. B65G 47/90

(52) U.S. Cl. CPC B65G 47/90

(57) ABSTRACT

Provided is a hook, a latch, and a pick-and-place system. The hook, in one aspect, includes an elongated member having a first end and a second end, as well as two or more pins coupled proximate the first end of the elongated member. The hook, according to this aspect, further includes one or more elongated lugs positioned substantially parallel with the elongated member between the two or more pins and the second end.

### CROSS-REFERENCE TO RELATED APPLICATION

This application claims the benefit of U.S. Provisional Application Ser. No. 63/272,572, filed on Oct. 27, 2021 entitled “DELIVERY DEVICE,” as well as U.S. Provisional Application Ser. No. 63/307,466, filed on Feb. 7, 2022 entitled “ROTOLATCH CONFIGURATIONS,” both of which are commonly assigned with this application and incorporated herein by reference in their entirety.

### TECHNICAL FIELD

This application is directed, in general, to a hook (e.g., coupling device) or latch and, more specifically, to an advanced pick-and-place system and applications thereof.

### BACKGROUND

Fasteners are ubiquitous. A quick trip to the hardware section of any home center will readily reveal the broad selection of fasteners. Screws, bolts, rivets, wall anchors, cotter pins, magnets, latches, etc., serve to enable one object to be fastened permanently or temporarily to another object. Seemingly, the choices are so broad that there is likely a specific fastener for every specific application.

Many assembly line operations use fasteners, such as bolts or screws, to couple two separate parts together. However, in many automated assembly line operations it is desirable to grasp an assembly with a robotic arm and temporarily relocate the assembly to the next station where assembly continues. In some applications magnetic or vacuum forces are employed to grasp the assembly for transport. However, in some applications magnetic forces may be undesirable because of the nature of the assembly which may be adversely affected by magnetism. Similarly, other assemblies may be unsuitable for the use of vacuum force because of insufficient area to affect a secure grasp of the assembly, excessive weight of the workpiece, etc.

In addition, online marketing companies and many of the world's largest package delivery services (Amazon, UPS, DHL, Dominos, etc.) are spending heavily to advance autonomous, drone-based package delivery. As a result, there are numerous working prototypes currently in existence. These prototypes vary widely in where they carry their payloads, how they collect and drop off these payloads, in overall design of the drone, and more. For example, where Amazon Prime Air employs an anchor-dependent (e.g., the package is coupled directly to the drone) delivery drone, Wing employs a tether-dependent delivery drone.

The current methods of drone delivery in the market have several limitations. For example, drones have not been able to pick up packages without the assistance of human workers or intricate external automated devices, which makes it difficult to fully automate the drone delivery process and therefore reduces delivery cost efficiency. The hardware and components required to operate actuators add to the weight of the drone and complicate the process of loading the package onto the drone. Delivery range is limited by the additional weight and energy costs of these designs, and drop-off locations are limited by the capabilities of the type of drop-off system used. Furthermore, if manual loading and unloading is required, delivery times are limited by the availability and location of any customer receiving a package. A system that allows fully automated loading and unloading in a wider range of pick-up and drop-off locations is therefore desirable to industry and solves many of the design challenges currently facing drone delivery systems.

### BRIEF DESCRIPTION

Reference is now made to the following descriptions taken in conjunction with the accompanying drawings, in which:

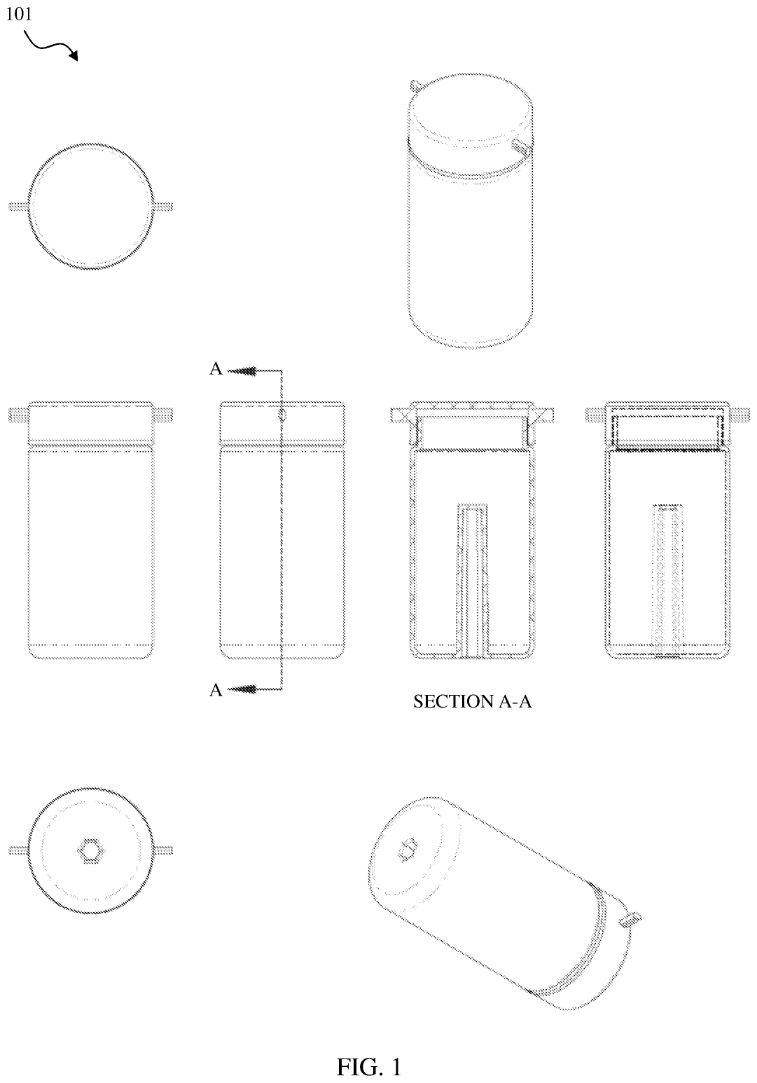

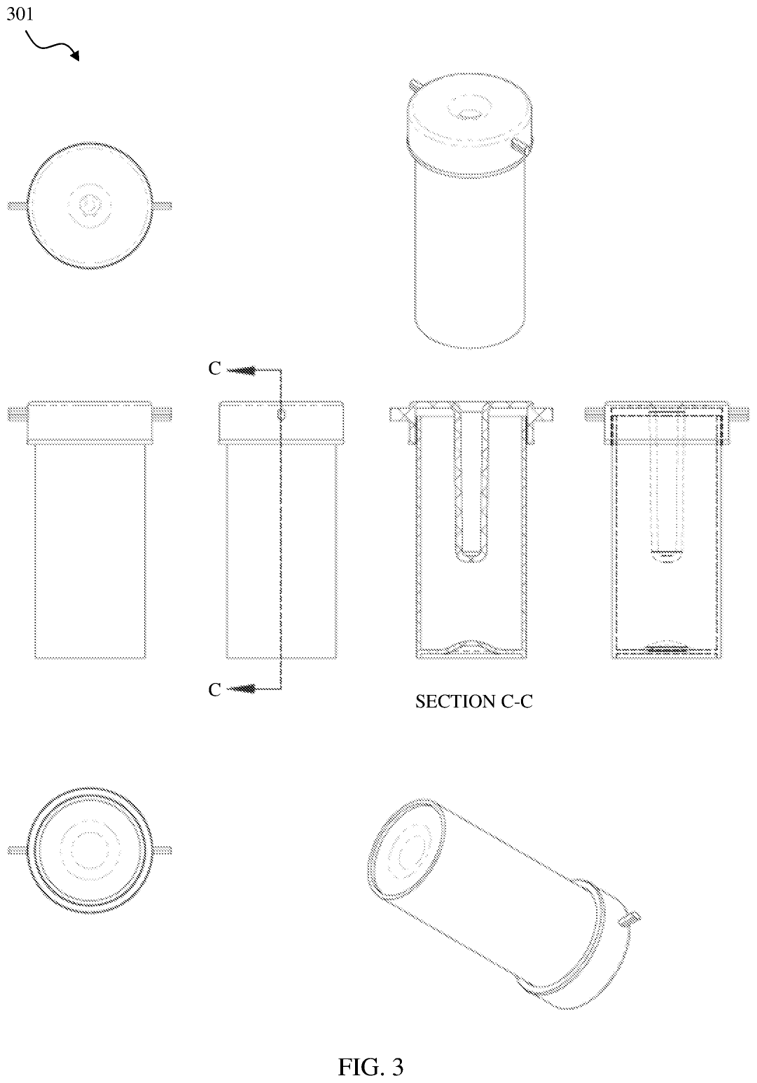

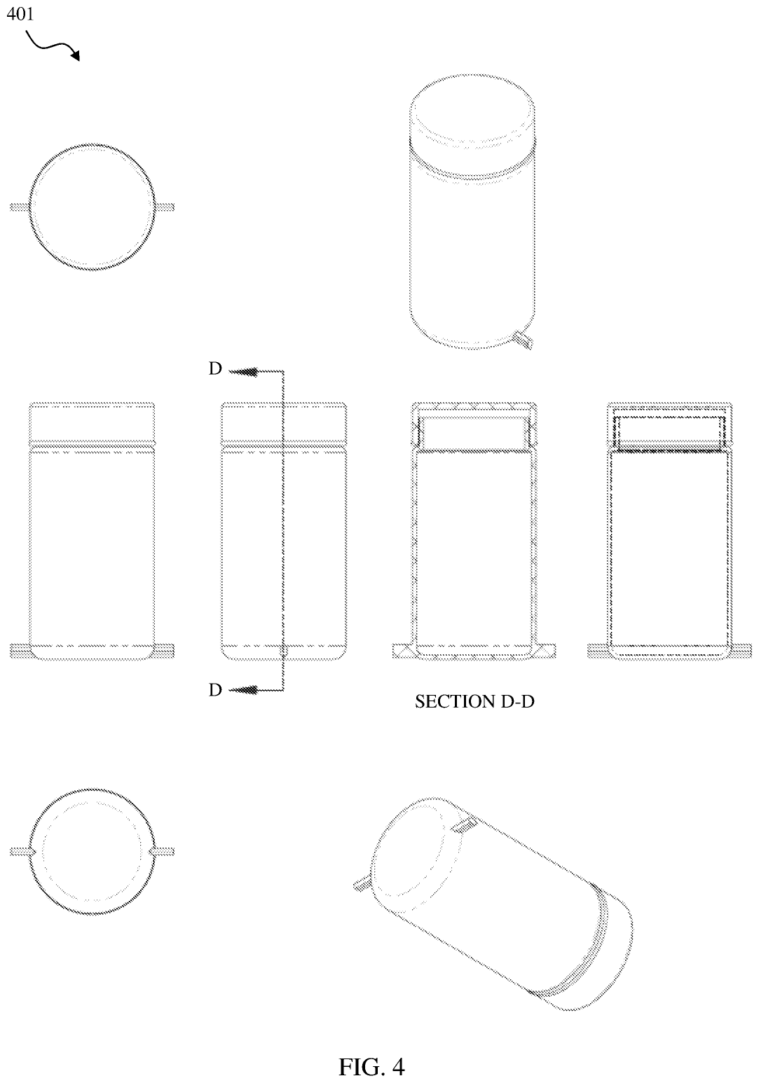

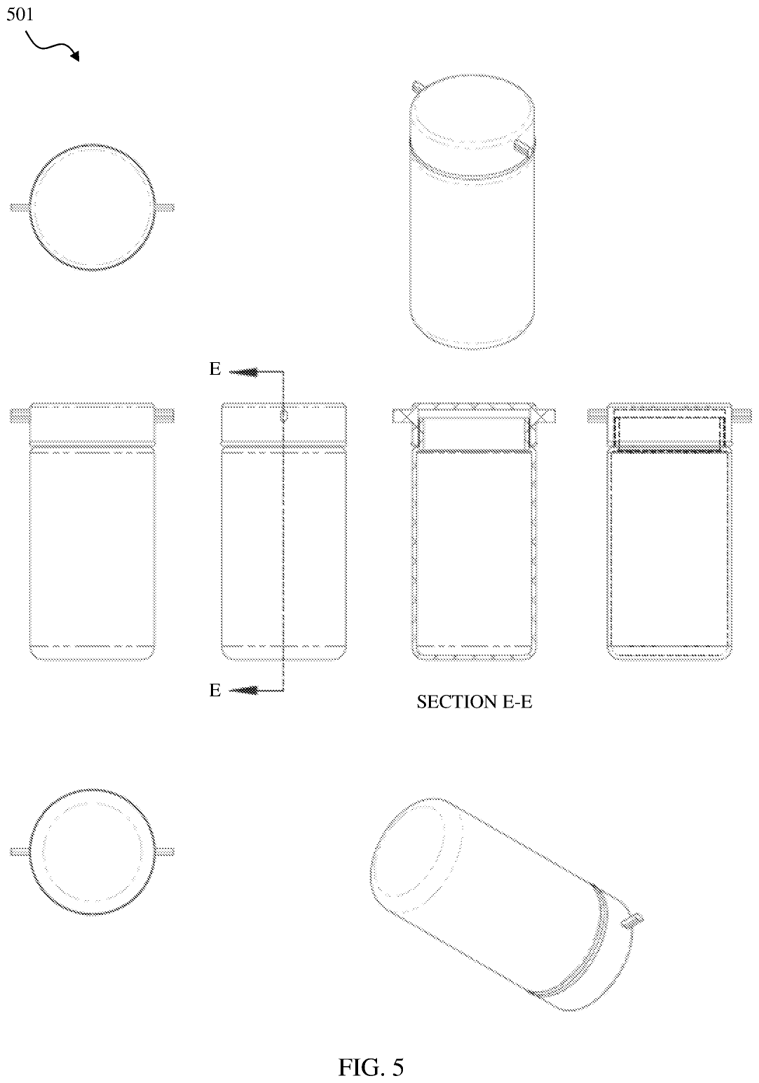

FIGS. 1 through 5 illustrate various different views of different embodiments of a hook container designed, manufactured and/or operated according to one or more embodiments of the disclosure;

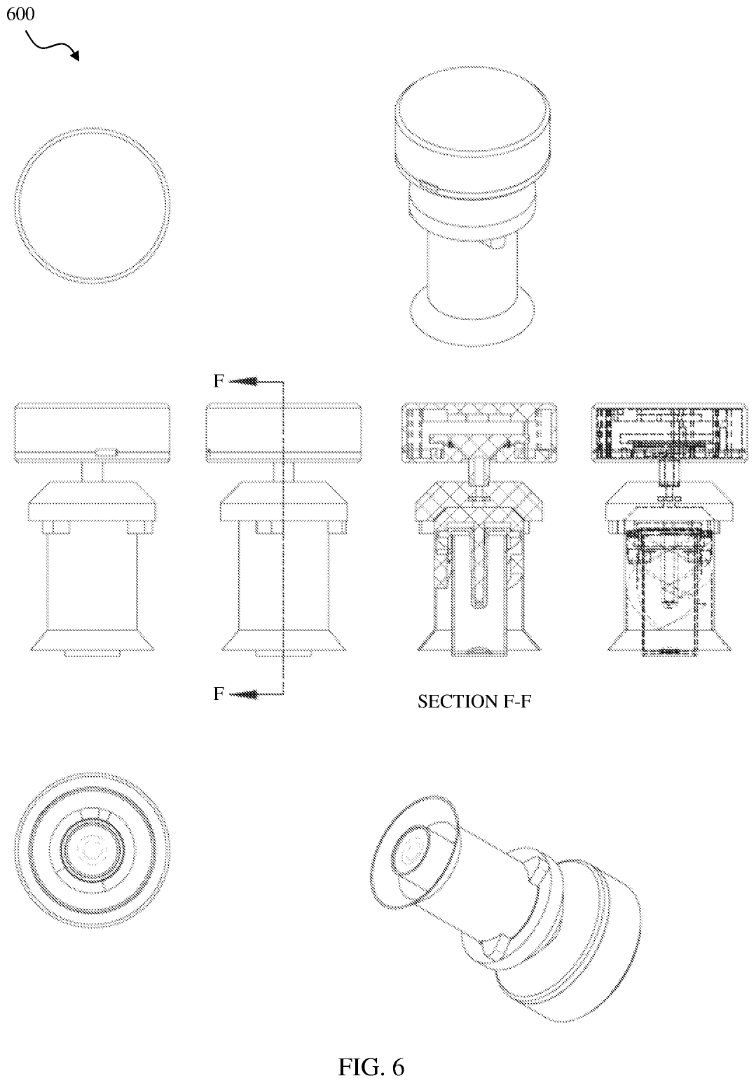

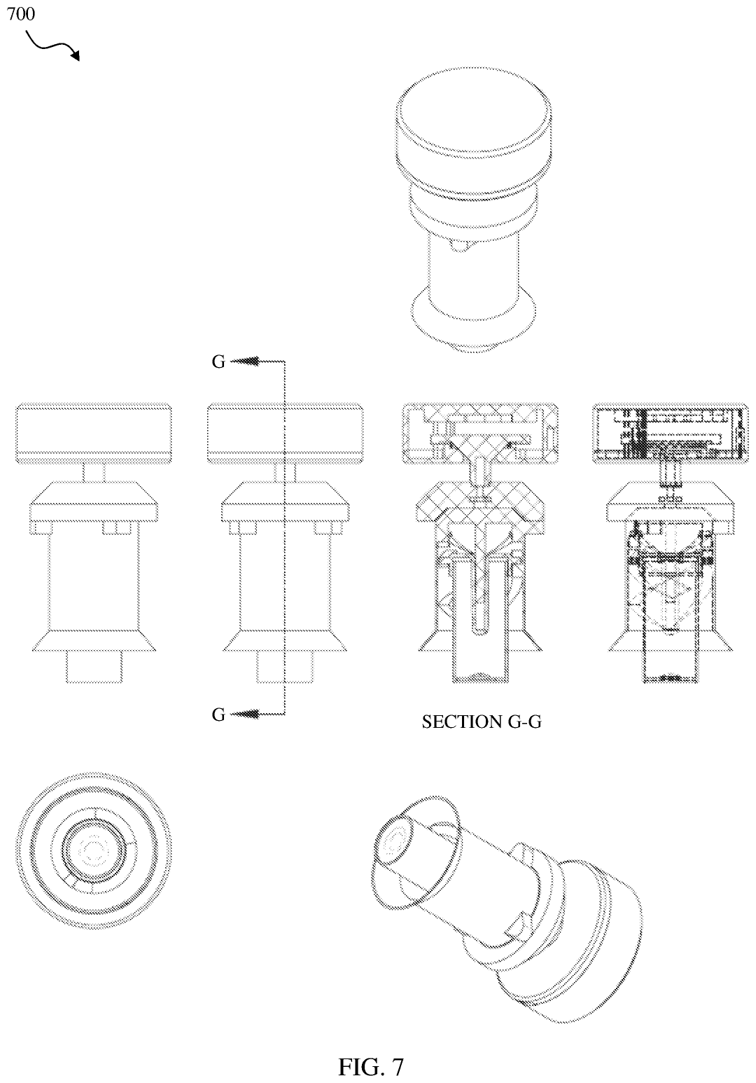

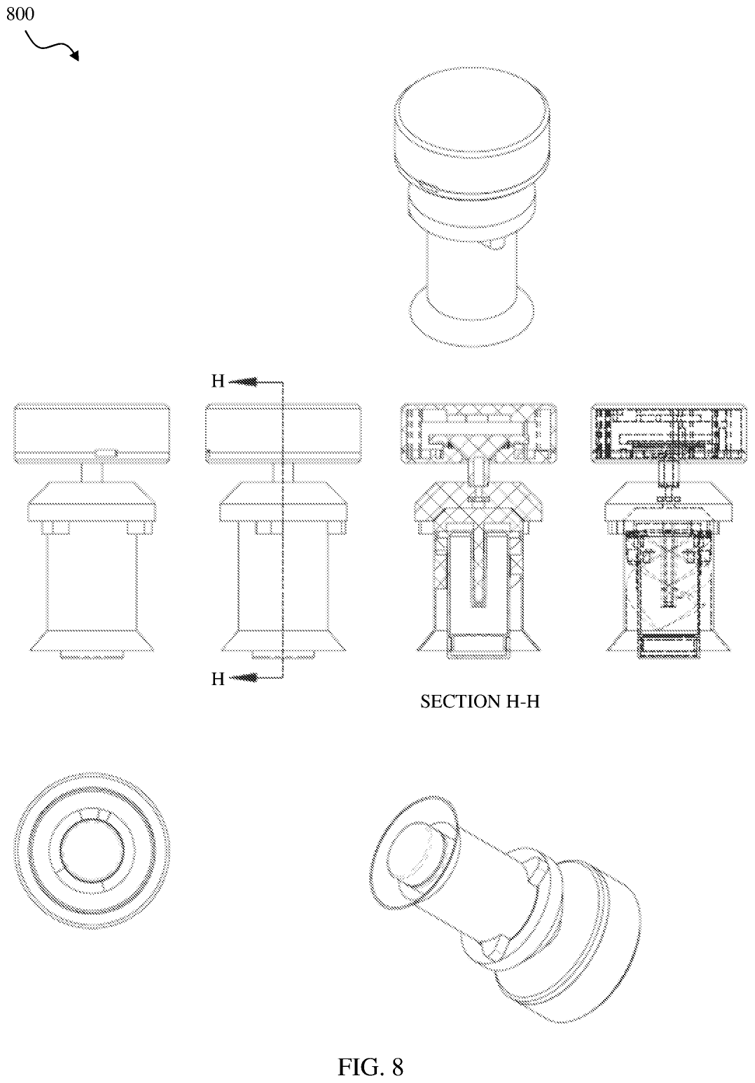

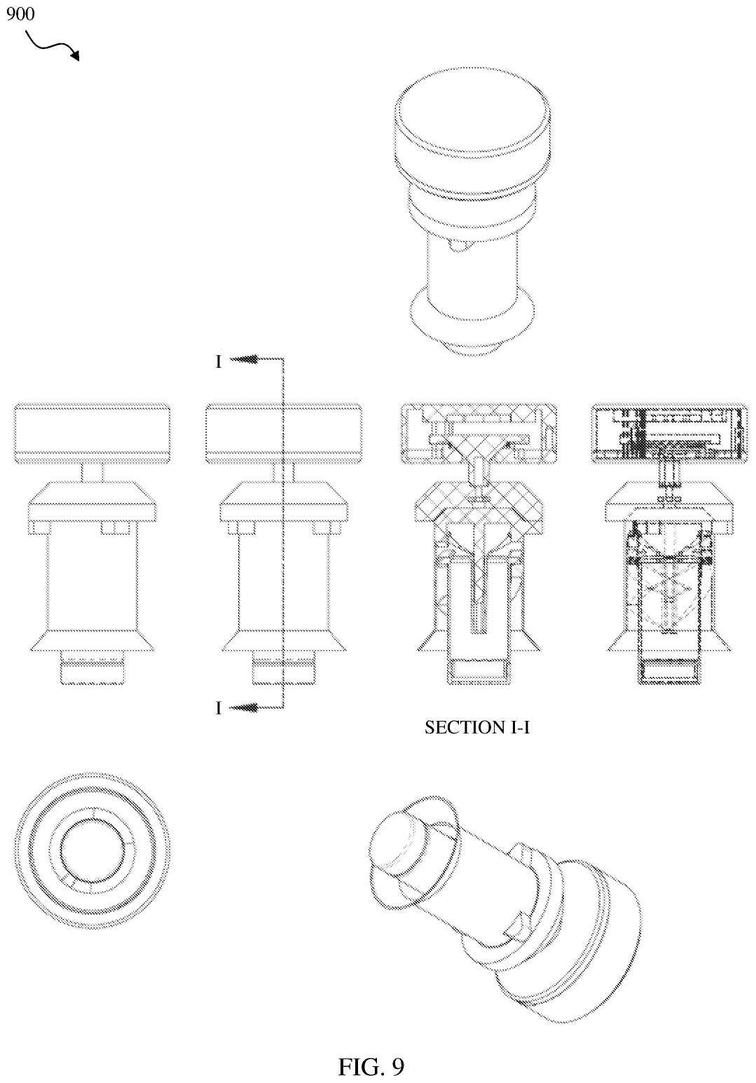

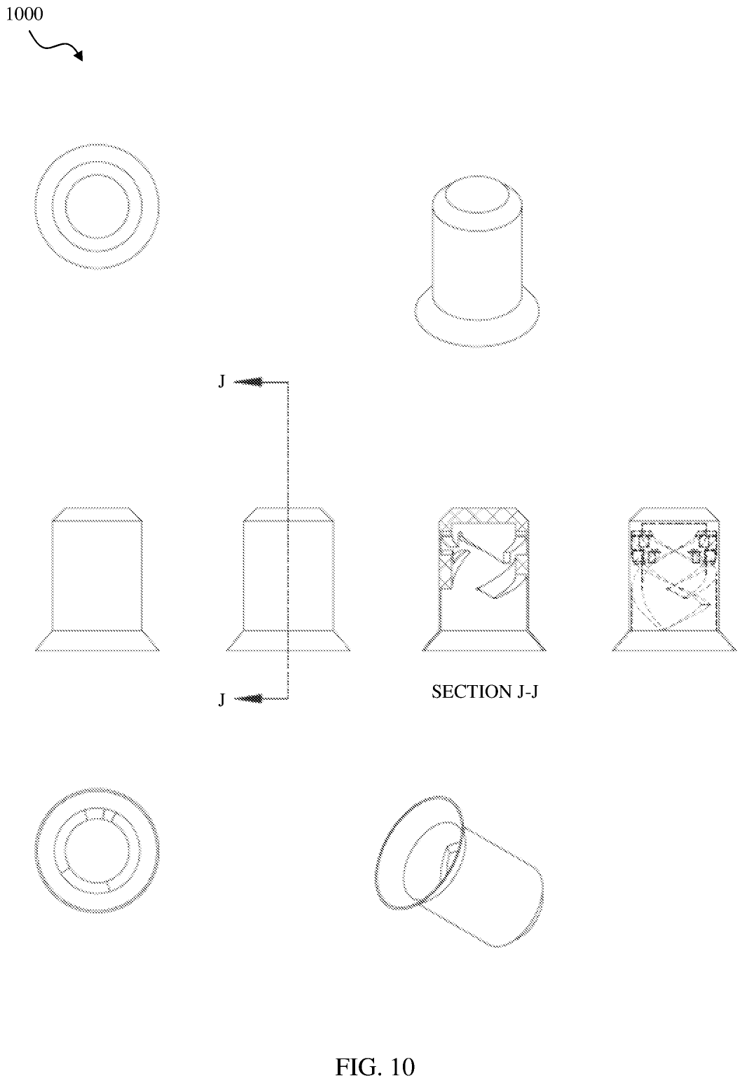

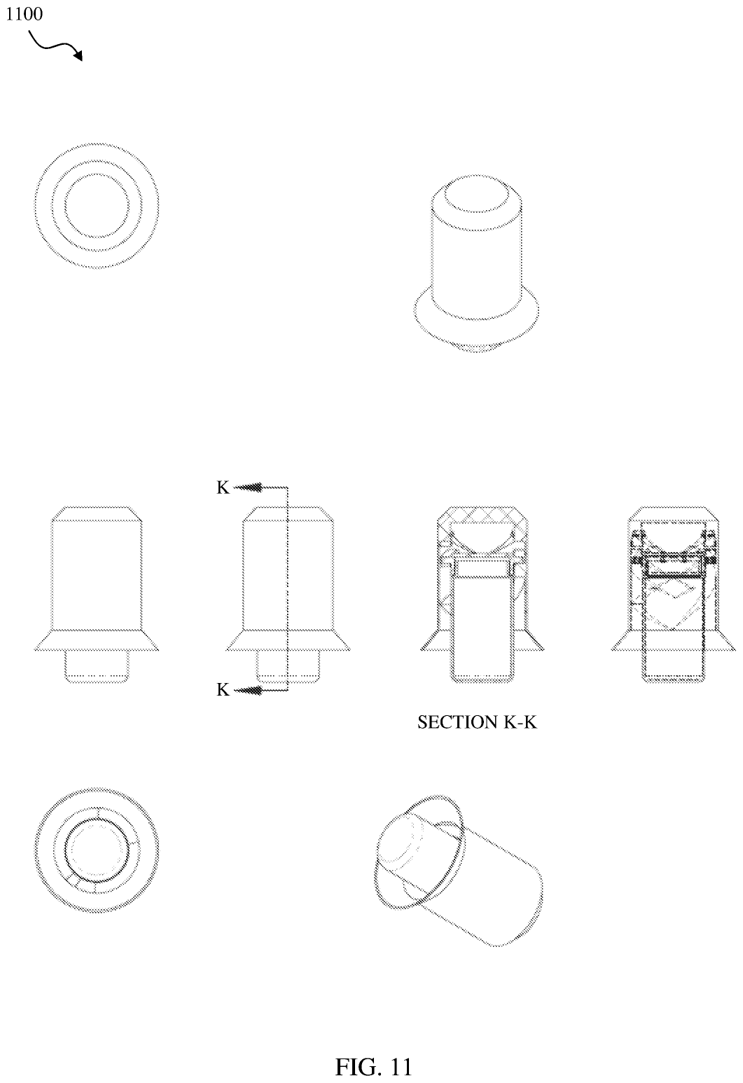

FIGS. 6 through 11 illustrate various different views of a pick-and-place system employing more or more of the hook containers designed, manufactured and/or operated according to one or more embodiments of the disclosure;

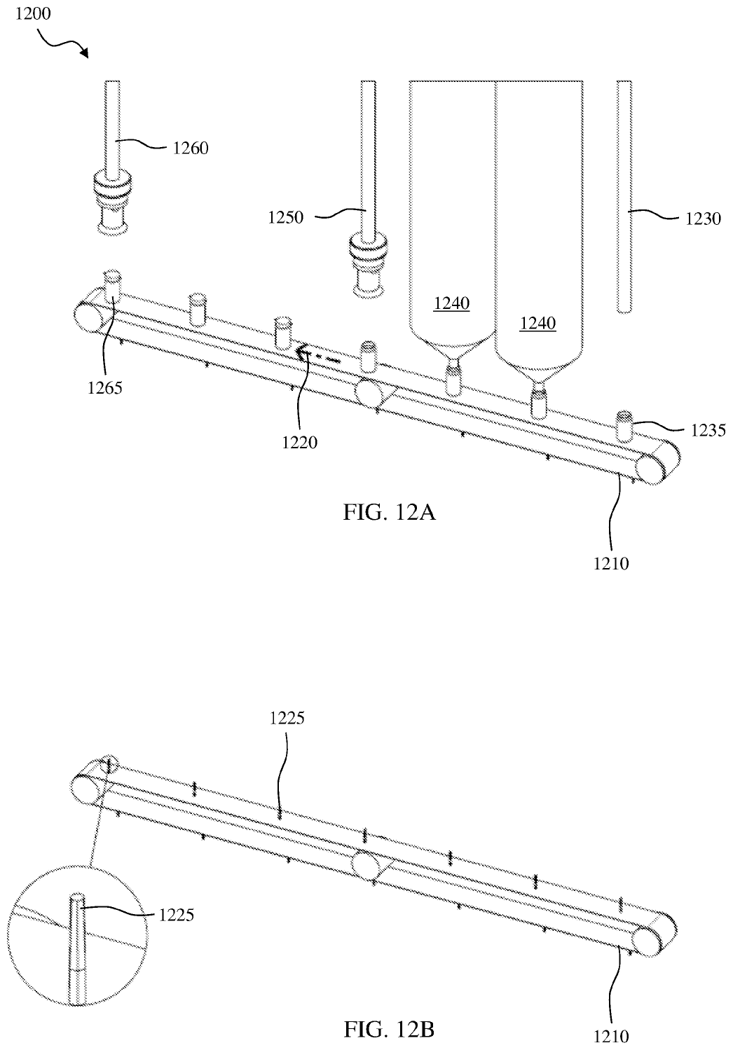

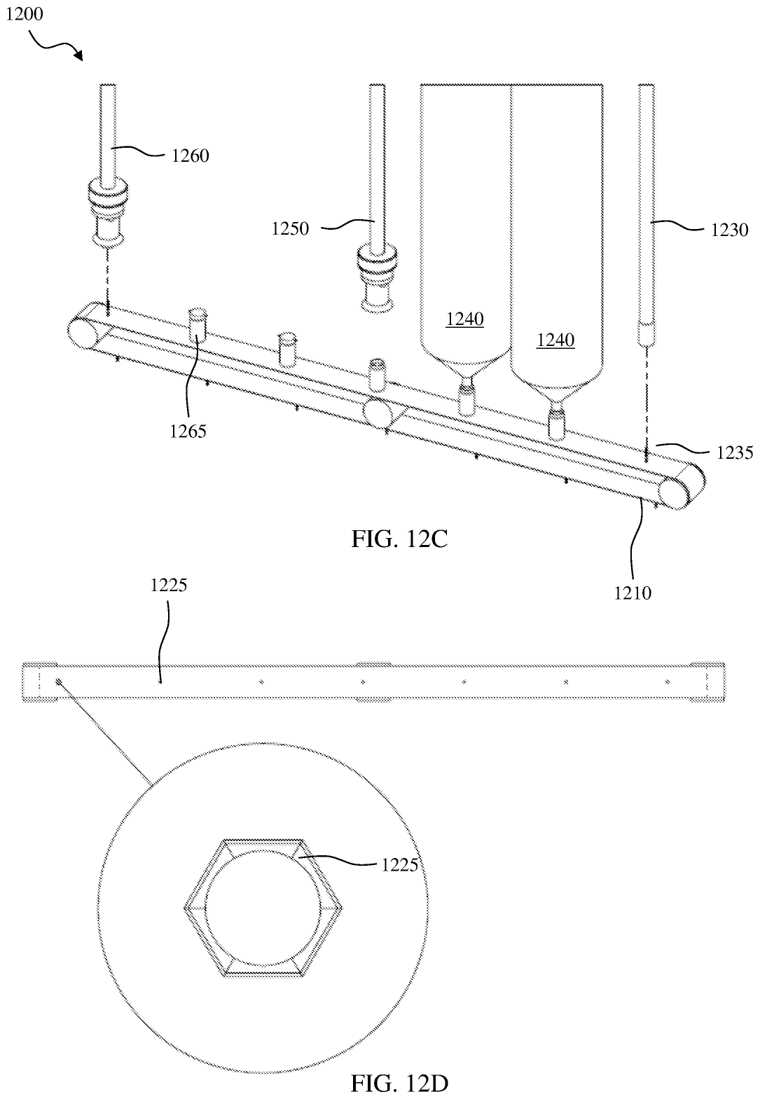

FIGS. 12A through 12D illustrate various different views of an automated filling and assembly system, which could employ one or more of the pick-and-place systems and/or hook containers, designed, manufactured and/or operated according to one or more embodiments of the disclosure;

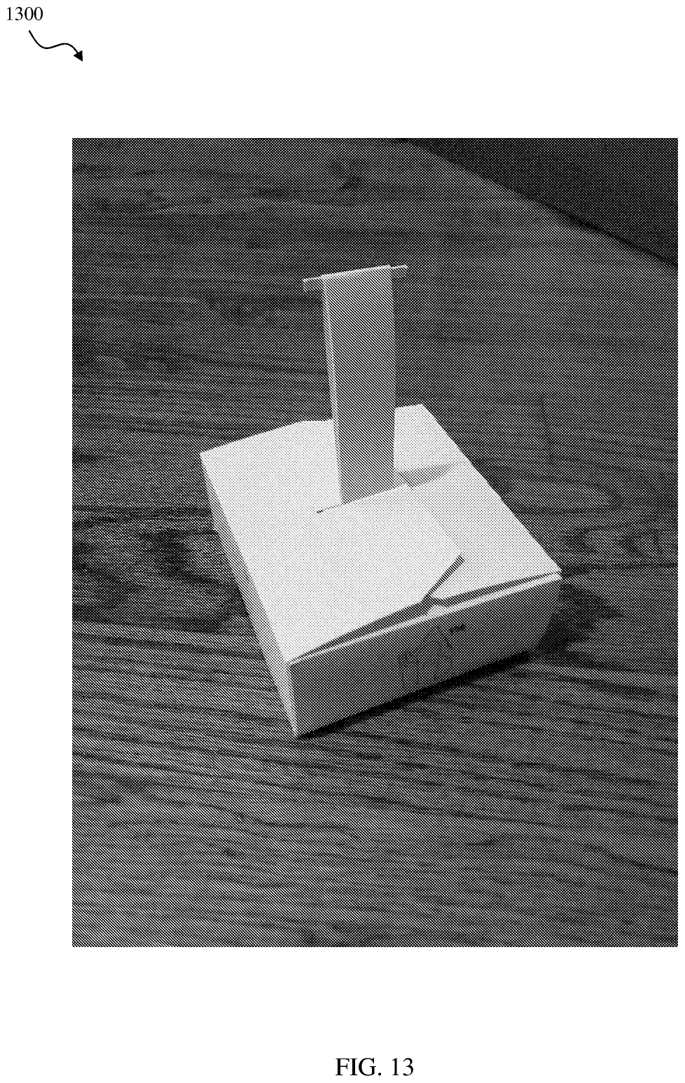

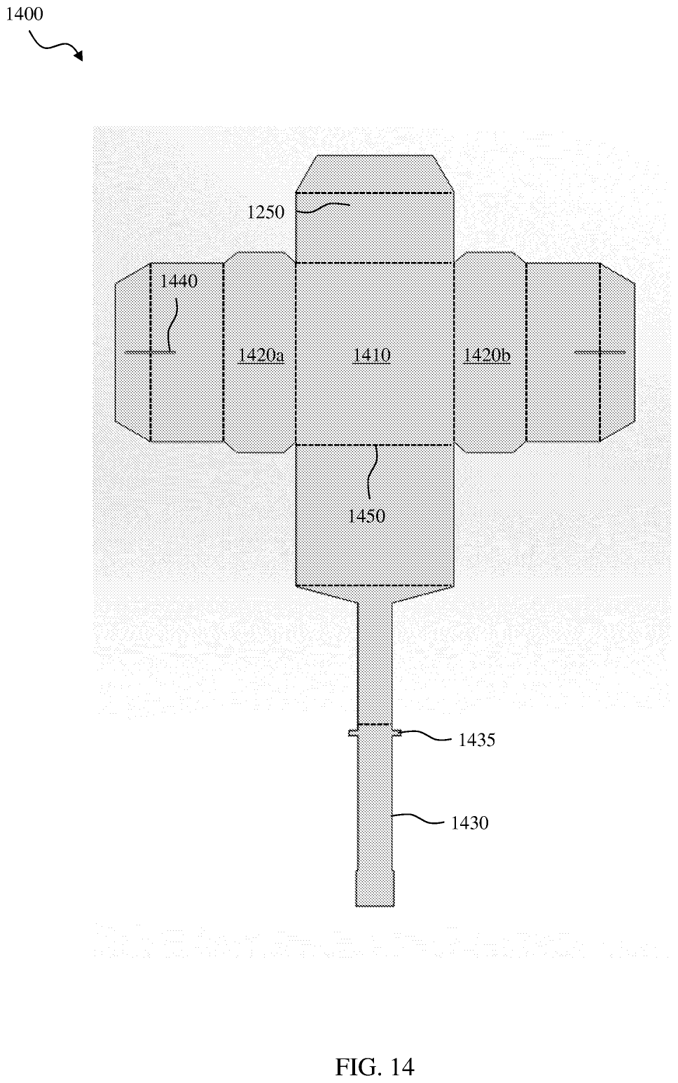

FIG. 13 illustrates how a container (e.g., box) can be formed out of one or more pieces of cardboard, cardstock, paper, etc. to form an enclosure with an integrated hook;

FIG. 14 illustrates one embodiment of a box pattern that might be used to form a container, such as the container of FIG. 13;

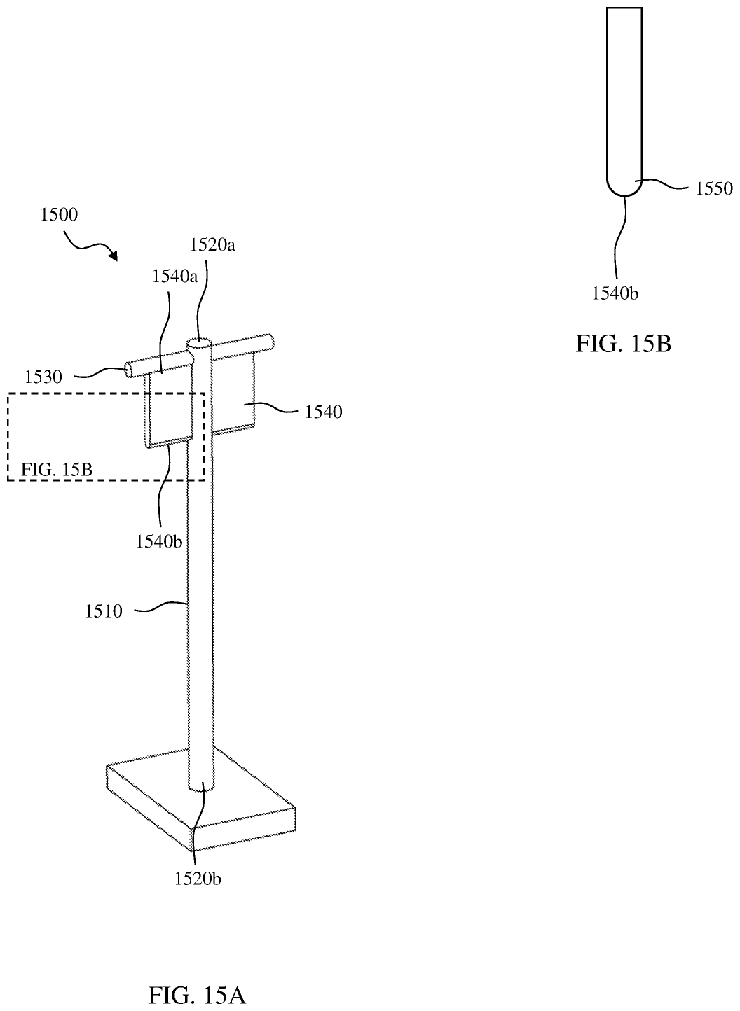

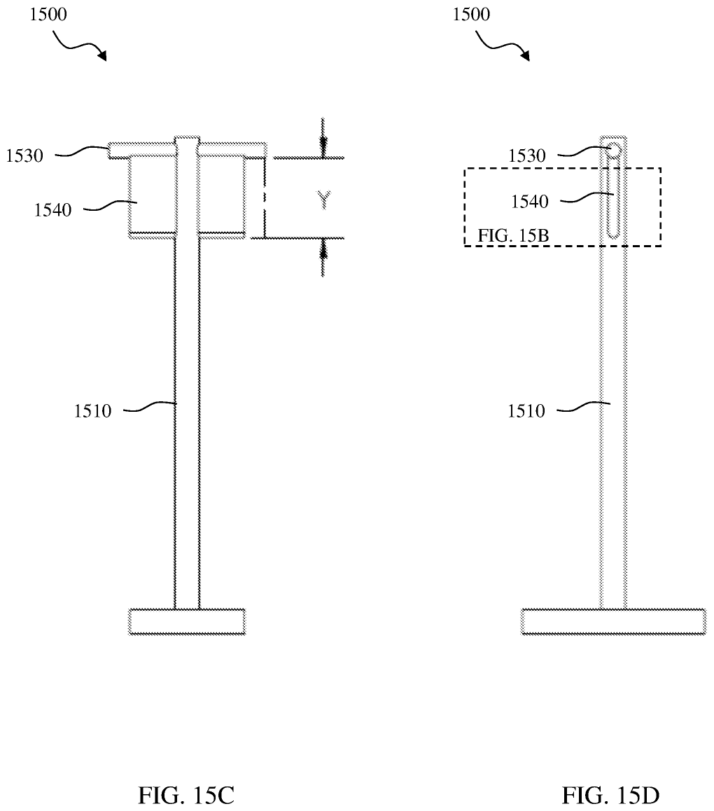

FIGS. 15A through 15D illustrate an improved hook designed, manufactured and/or operated according to one or more embodiments of the disclosure;

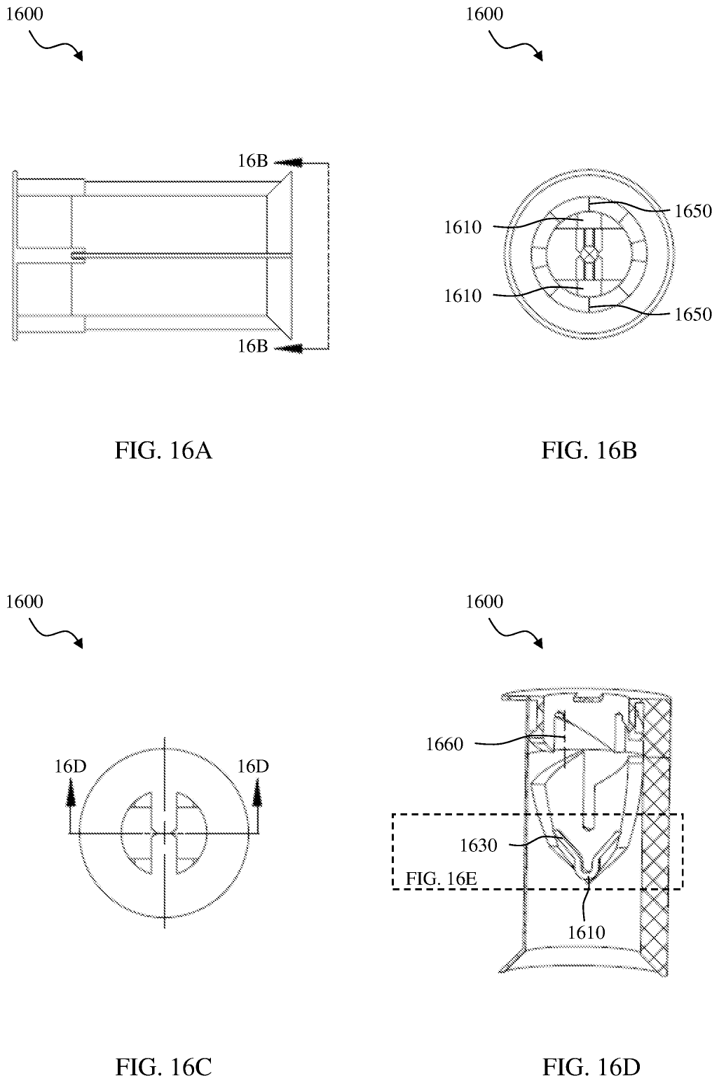

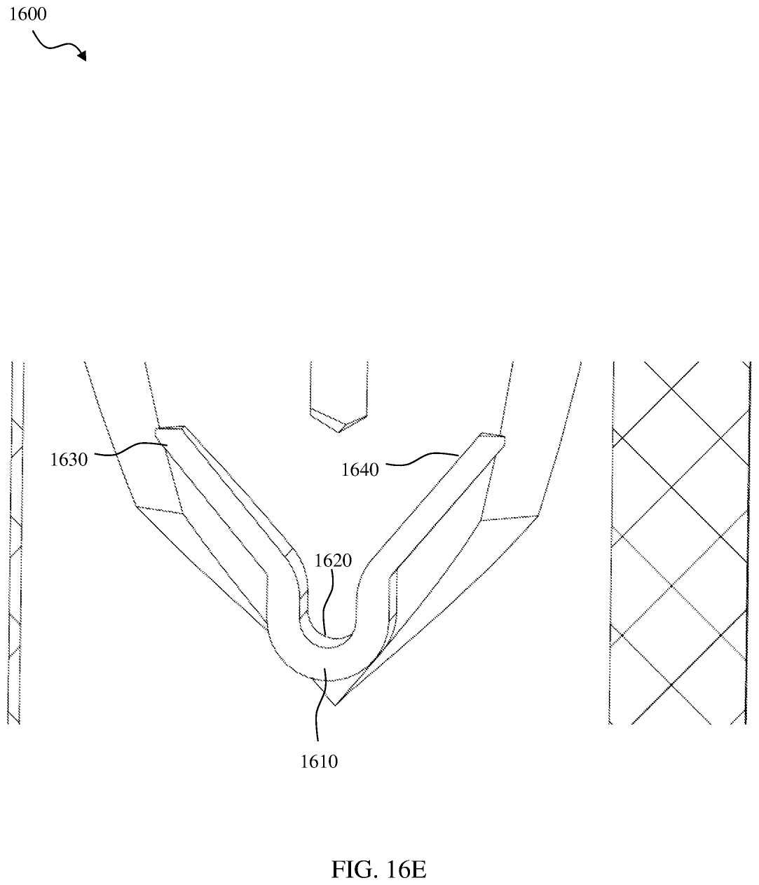

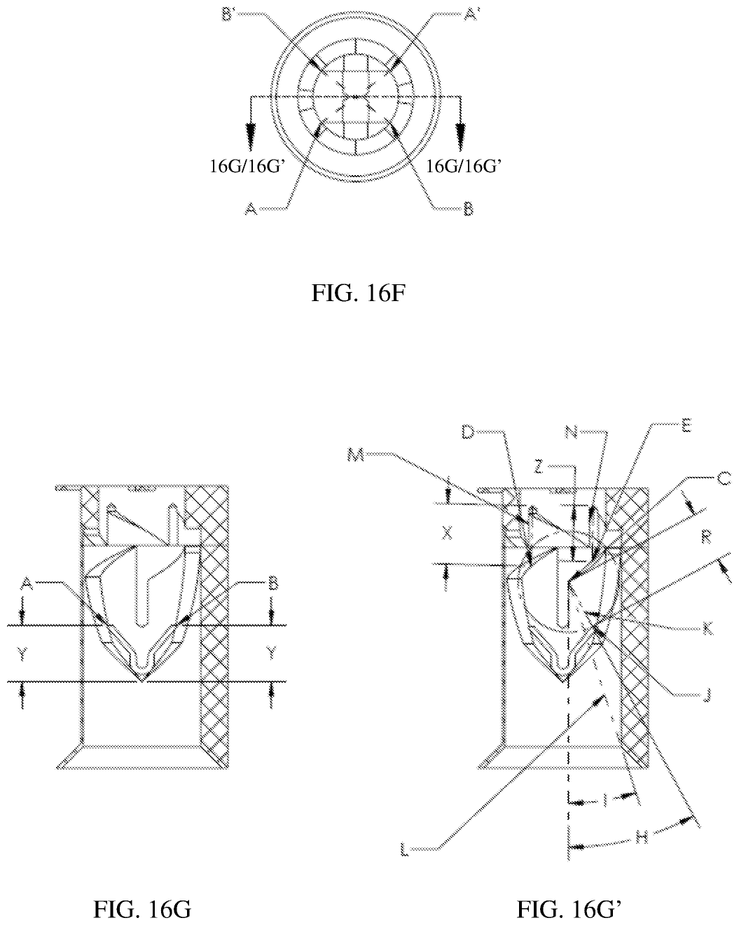

FIGS. 16A through 16G′ illustrate various different views of a latch designed, manufactured and/or operated according to one or more embodiments of the disclosure;

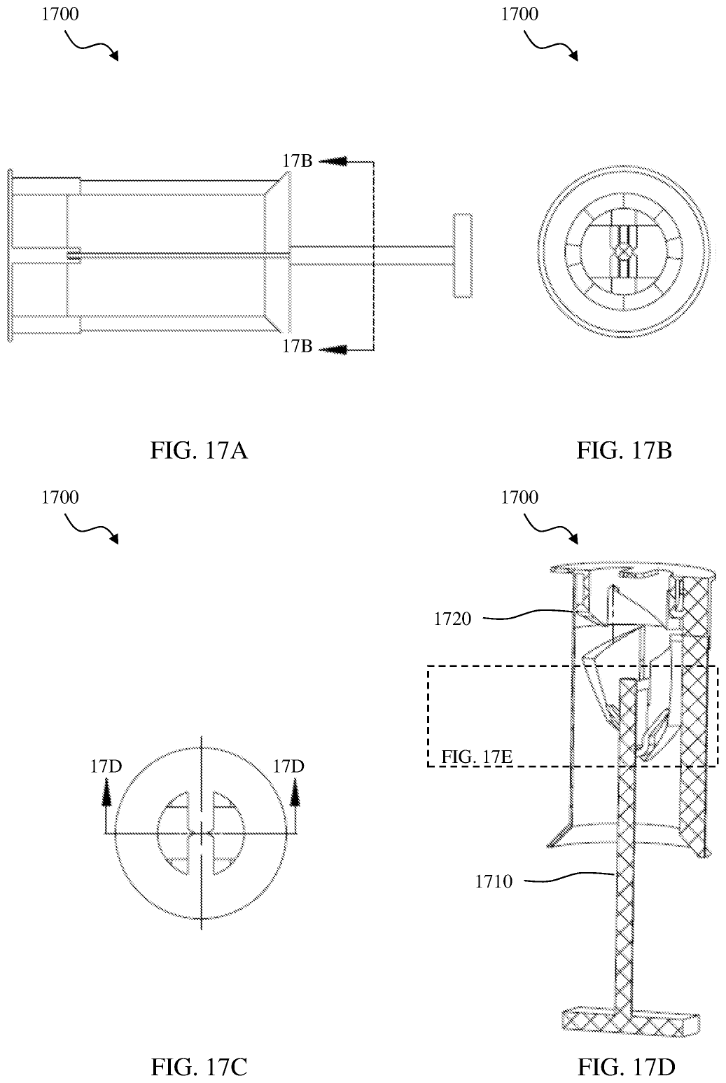

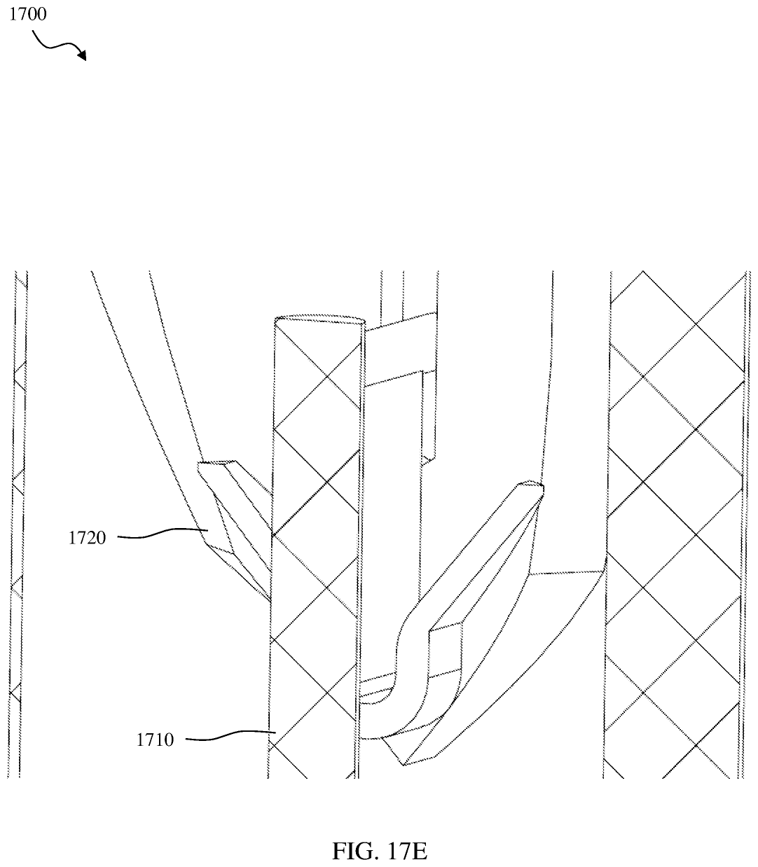

FIGS. 17A through 17E illustrate different views of one embodiment of a pick-and-place system, having a hook and latch designed, manufactured and/or operated according to one or more embodiments of the disclosure;

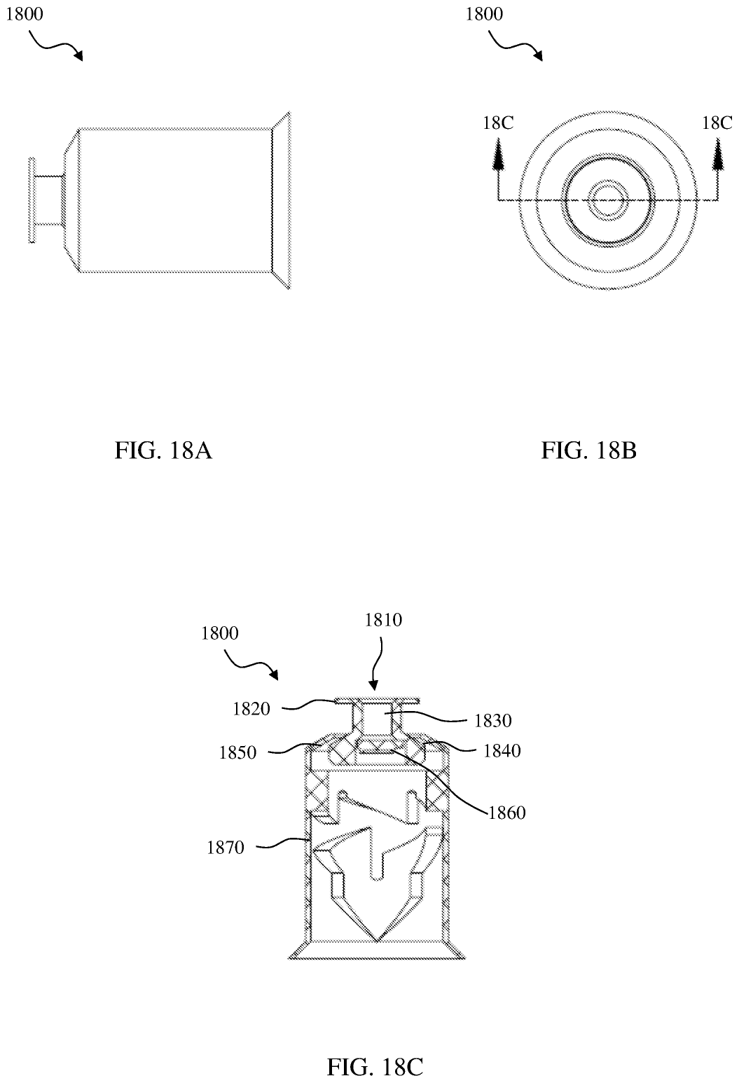

FIGS. 18A through 18C illustrate an alternative embodiment of a latch designed, manufactured and/or operated according to one or more embodiments of the disclosure;

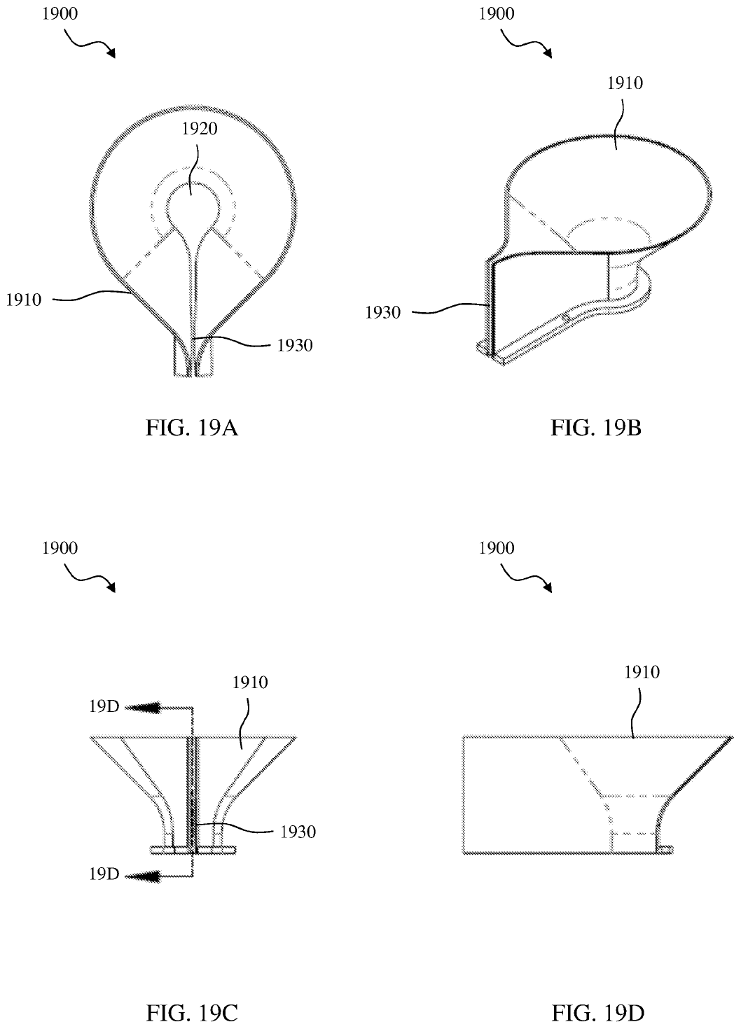

FIGS. 19A through 19D illustrate various different views of a centering cone designed, manufactured and/or operated according to one or more embodiments of the disclosure;

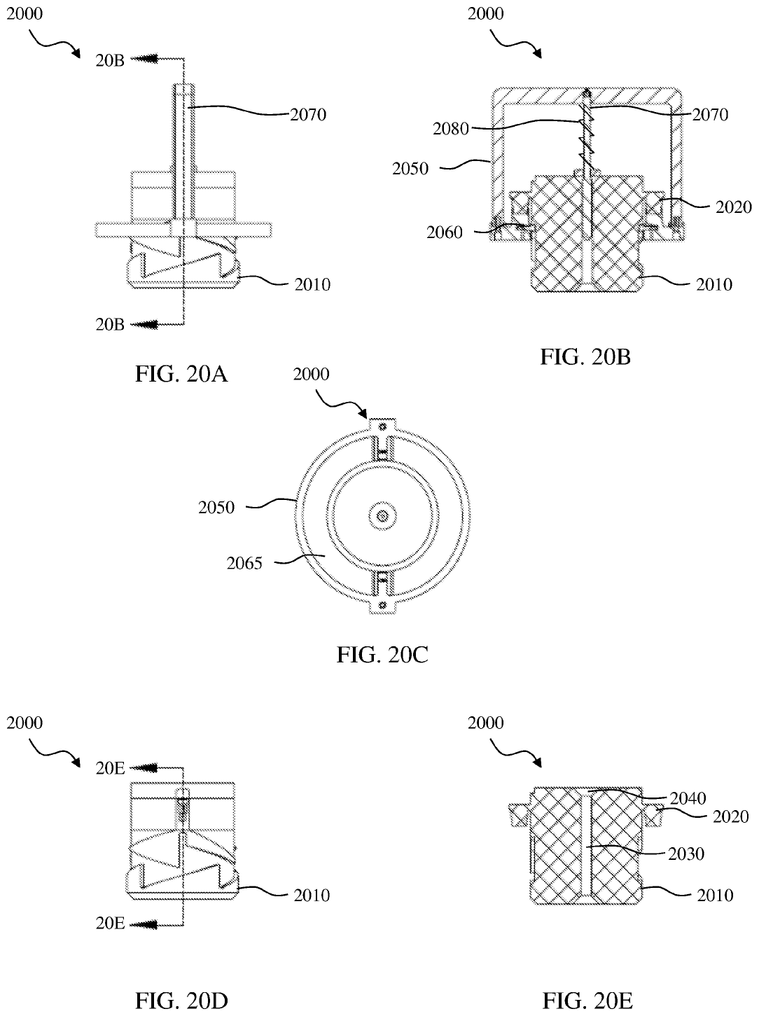

FIGS. 20A through 20E illustrate various different views of a battery system according to one or more embodiments of the disclosure;

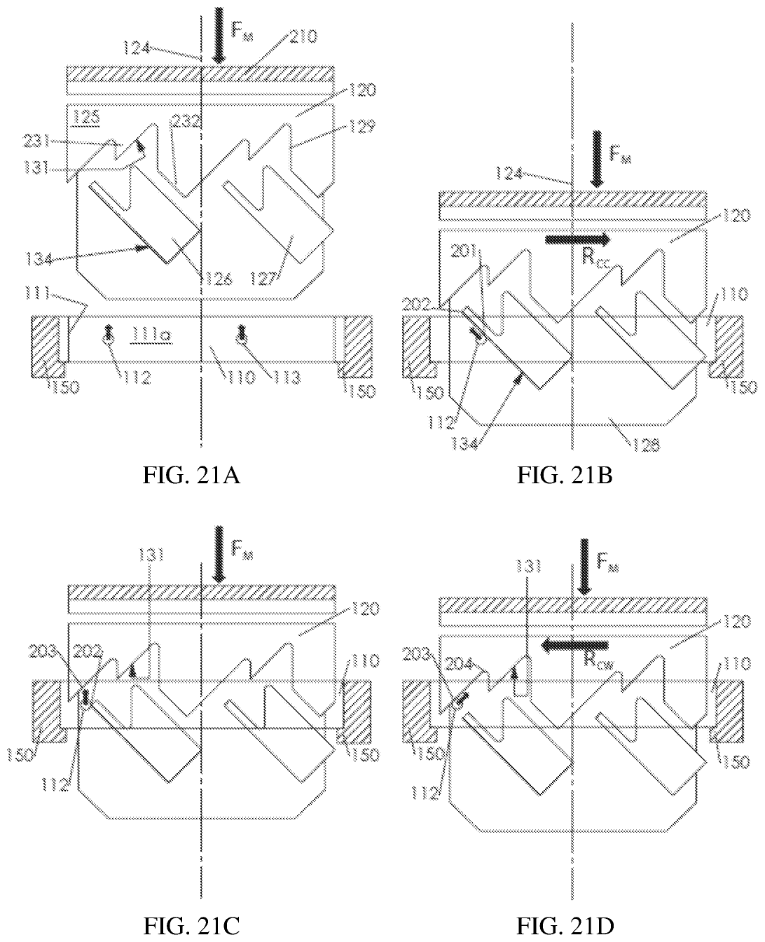

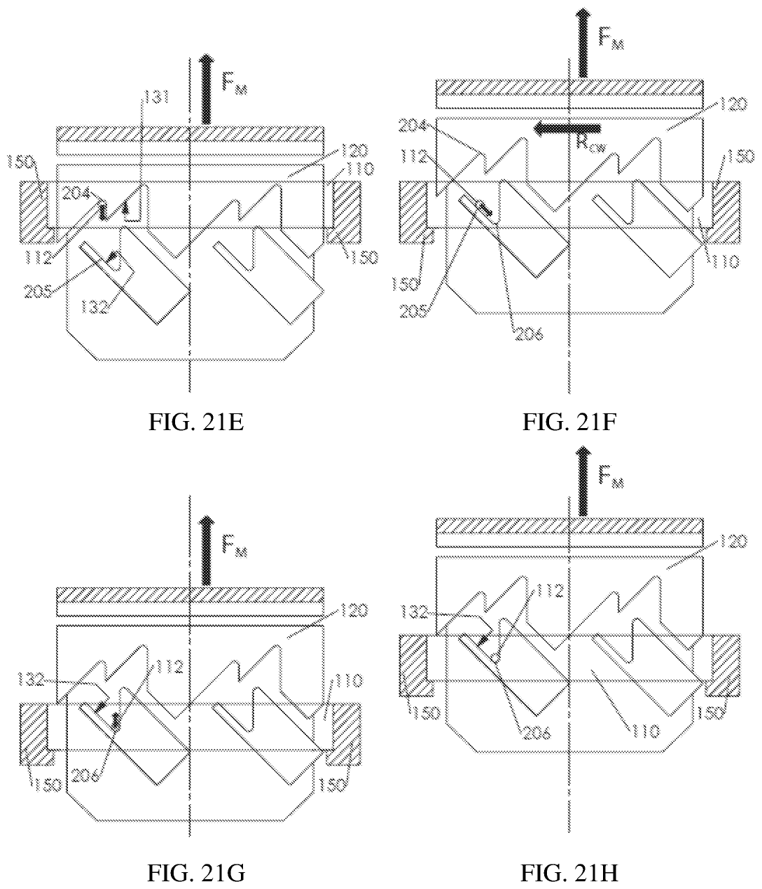

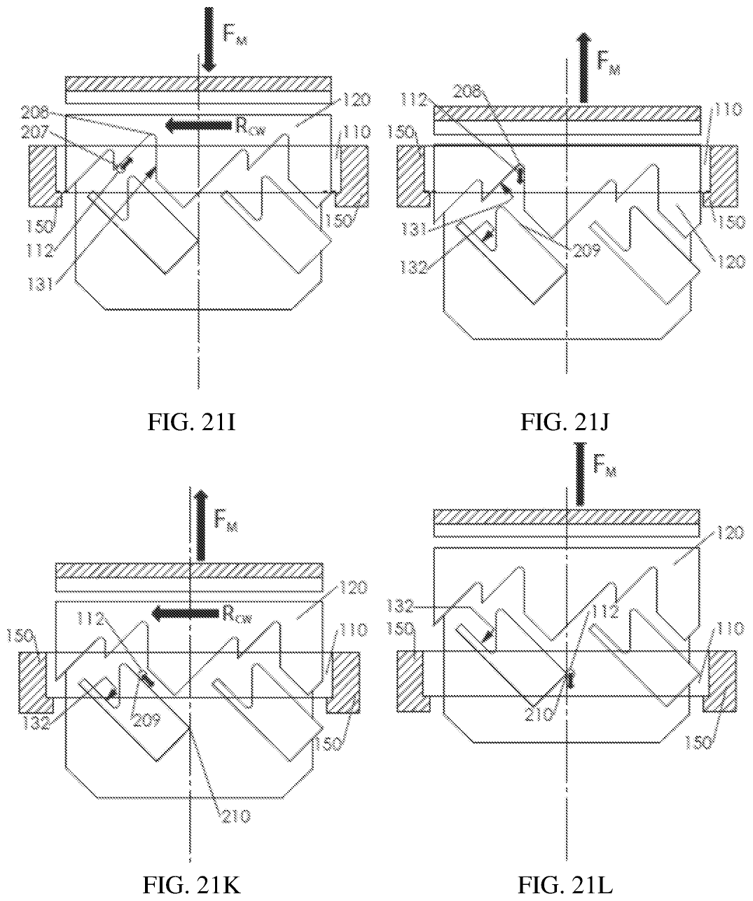

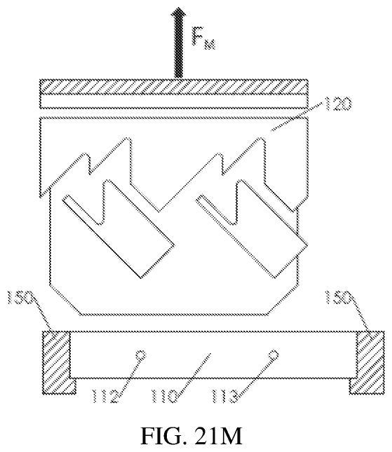

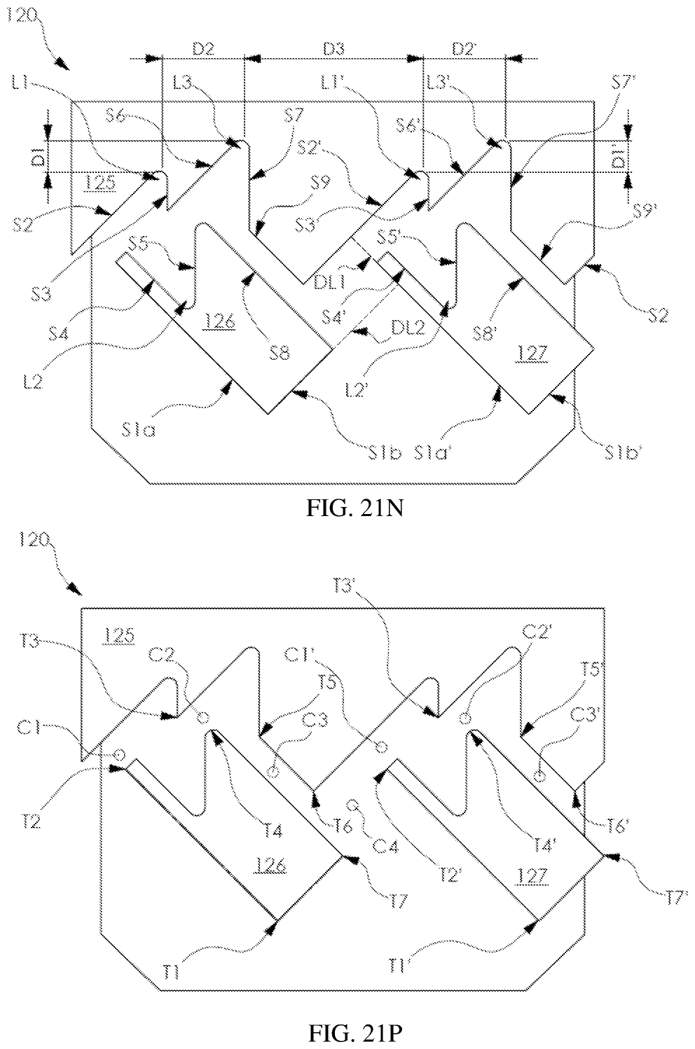

FIGS. 21A through 21P illustrate one embodiment of how a pick-and-place system might be used according to one or more embodiments of the disclosure; and

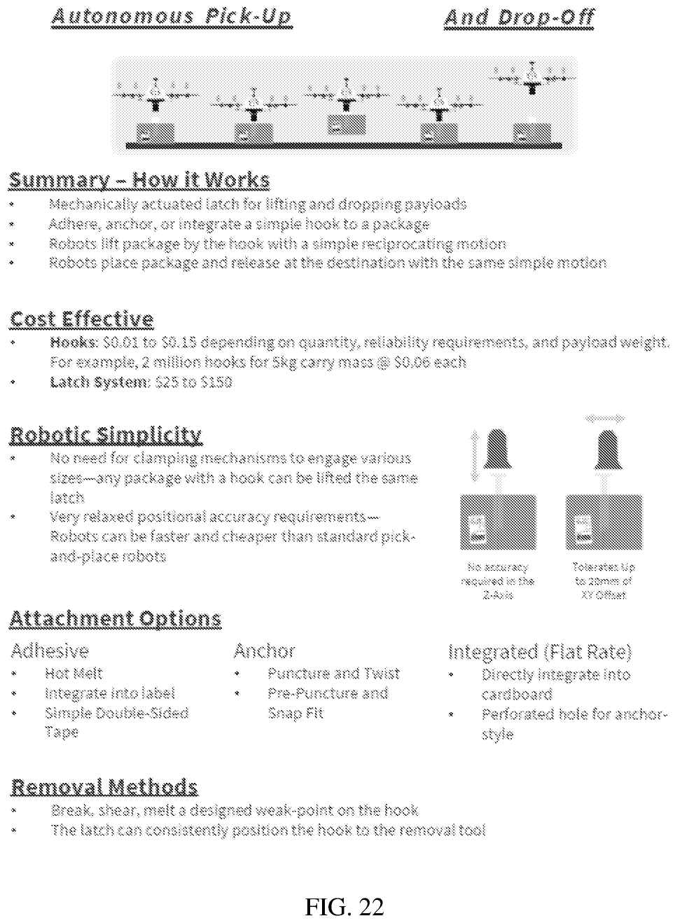

FIG. 22 illustrates a summary of one embodiment of autonomous pick-up and drop-off according to one or more embodiments of the disclosure.

### DETAILED DESCRIPTION

### Definitions

Active Time—Time spent in Drone Active Mode in a single Work Cycle.
Allowable Bearing Angle—The maximum title angle allowed by the bearing system.
Angular Misalignment—The angular difference between the central axes of the Hook and the Latch.
Arm—Arm refers to the component of the frame attached to the upper and lower plates and supporting the motors.
Balanced Flight—Flight where the payload is mostly centered with respect to the propellers (not imbalanced).
Base Delivery Truck—A vehicle (truck, van, larger drone, boat) with one or more base stations and a set of packages. The Base Delivery Truck could have some level of robotics to assist drones in picking up the packages, or it could have the packages pre-organized so the drones pick up the packages without assistance.
Base Station—A collection of devices that could facilitate landing of a drone, exchange of a battery, and/or charging of batteries. It could include a power source.
Bearing—The bearing assembly that holds the Latch. Typically, this will allow for limited angular, axial, and radial movement.
Bell—This is an extension of the LCD, extending downwards and increasing in diameter.

This is configured to contact the Pins when the Hook and Latch are misaligned and help realign the two.
Cam Diameters (CD)—On the Latch Cam Diameter (LCD), this is the approximate outer diameter of the cam surfaces (which might be conical to some degree, possibly to allow for injection molding). On the Hook Cam Diameter (HCD), this is the diameter of a circumscribing circle of the pins on the hooks.
Catch Surface—The surface leading to the Lower Vertical Limit, guiding the Pin from the First Upper Vertical Limit
Charge Station—A Base Station that charges a landed drone directly.
Charge Time—Time spent in Drone Charge Mode in a single Work Cycle.
COM—Center of Mass.
Conventional Drone—A drone with only rechargeable batteries.
Cycle Time—The time it takes a drone to complete a full Work Cycle.
Direction—For the purposes of this explanation, the latch is positioned above the hook with opening of the latch facing downwards to the hook to receiver the pins.
Disengage—When the Latch moves downwards with respect to the hook, moving the pins from the Lower Vertical Limit to the Second Upper Vertical Limit, thus priming the system to release the hook.
Disengagement Failure—This refers to when the Latch attempts to disengage the Hook, but fails. This could happen if the Pins start at the Lower Vertical Limit, and then as the Payload is rested on the ground, there is enough angular momentum back in the direction of the First Upper Vertical Limit that the Pins move towards the First Upper Vertical Limit, rather than the Second Upper Vertical Limit.
Drone—This may refer to a multi or single rotor, unmanned copter, but in most cases, it can also include other robots and even manually operated cranes.
Drone Active Mode—Drone is actively completing desired tasks, draining battery.
Drone Charge Mode—Drone is at a Charge Station.
Drone Efficiency Improvement—The number of additional Conventional Drones a similarly configured Swappable Battery Drone can replace in terms of Active Time.
Drone Return Mode—Drone is returning to or from the base-station, draining battery, but not doing desired tasks or charging batteries.
Drone Swap Mode—Drone is actively swapping a battery at a Swap Station. This is part of the Drone Return Mode because it can swap batteries in the same motion as landing.
Engage—When a Latch receives a Hook and the Pins reach the First Upper Vertical Limit, thus priming the system to be able to lift the Payload.
Engagement Failure—This refers to when the system attempts to engage the Hook, but fails. This can be due to Jamming or Peak Sticking, especially if it falsely triggers the Engagement Sensor.
Engagement Sensor—A sensor (often a switch or array of switches) configured to detect when the pins have reached a Vertical Upper Limit. Different kinds of sensors can be used to detect which Upper Limit was reached, or the same Engagement Sensor can be used for all of the Vertical Upper Limits.
Exit Surface—The surface leading to exit the Latch, guiding the pin out after reaching the Second Upper Vertical Limit
First Peak—This is the offset peak that is furthest from the Vertical Limits, and thus, likely the first to engage with the Pins.
Height Offset at Max Tilt—This is the vertical offset of the ends of the two pins at Maximum Latch Tilt.
Hook—The hook portion of the pick-and-place system. This contains the pins that act as the cam followers. Hook refers to the part of the latch that remains attached to the package and mates with the lifter during engagement of the latch.
Imbalanced Flight—Flight where the payload is substantially (e.g., by 5% or more of the maximum distance between propellers) off centered with respect to the propellers.
Inner Bearing—This is part of the bearing if rigidly attached to the latch and contained within the Outer Bearing.
Internal Battery—This term is used to describe a battery that cannot be automatically exchanged.
Jamming—When two or more Pins initially engage the Latch in such a way that they urge rotation in opposite directions, preventing rotation and further progression of the Pins through the Latch.
Latch—The latch refers to the system designed to engage and disengage a package, which includes both the lifter and the hook. The latching portion of the pick-and-place system. This contains the contours of the cam.
Leg—Leg refers to the components of the frame that connect to the arms and keep the drone body above the ground, as well as assisting in the pickup system.
Lifter—The lifter refers to the part of the latch that remains attached to the drone and mates with the hook during engagement of the latch.
Lower Vertical Limit—This is the primary engaged position of the pick-and-place system where the hook is held by the latch. A payload that is being carried by a drone would have a latch that is at the Lower Vertical Limit.
Maximum Detection Tilt—This is the maximum angle the latch can be tilted and still trigger the Engagement Sensor.
Maximum Latch Tilt—This is the maximum angle the latch can tilt within. This can be controlled by the bearing, possibly by the Switch or Switch Array.
Maximum Rotational Deviation—Given a pin positioned on the LCD, this is the angle between the other Pin if the Hook if it crossed the central axis of the Latch and a Pin on a hook at Worst Case Hook Offset with respect to the central axis of the Latch
Offset Peaks—Peaks where one or more are configured to be different vertical distances from the Vertical Limits.
Outer Bearing—This is the part of the bearing that is attached to the Drone and houses the Inner Bearing. It also may contain the sensors.
Payload—Any package, container, or item that is lifted and moved. It could be a package for delivery, a shipping container, etc. The hook may be on the Payload.
Payload Sensor—A sensor (often a switch) configured to detect the presence of a Payload, often by depressing a switch when the pins are at the Lower Vertical Limit.
Peak—The first point on the cam surface of the latch configured to interact with the pins and support guided rotation.
Peak Sticking—When one or more Pins engage close to or directly with a Peak, and thus do not urge enough rotation to rotate the Latch or Hook. Generally, this can occur when the Peaks are nearly perfectly aligned with the Pins. This differs from Jamming, where the Pins urge rotation, but they oppose each other.
Pins—The cam followers on the hooks. They do not necessarily need to be cylindrical.
Pitch—Rotation of the drone around the side-to-side axis.
Radial Misalignment—The separation between the central axes of the Hook and the Latch.
Receiving Diameters (RD)—On the Latch Receiving Diameter (LRD), this is the approximate inner diameter of the cam surfaces (which might be conical to some degree, possibly to allow for injection molding). On the Hook Receiving Diameter (HRD), this is the diameter of a circumscribing circle for the supporting portion of the pins that must fit within Receiving Diameter of the Latch. The HRD can be much less than the LRD, though closer values will help with Angular Misalignment and mechanical strength of the hook.
Return Time—Time Spent in Drone Return Mode in a single Work Cycle.
Roll—Rotation of the drone around the front to back axis.
Rotating (Rotation) Tension Latch—one or more embodiments of such described in U.S. Pat. No. 9,677,590, entitled “ROTATING TENSION LATCH,” filed Oct. 16, 2012; U.S. Pat. No. 10,844,894, entitled “ROTATING TENSION LATCH,” filed Jun. 12, 2017; U.S. Patent Pub. No. US 2021/0033131 A1, entitled “ROTATING TENSION LATCH,” filed Oct. 21, 2020; and International Publication No. WO 2021/154875 A1, entitled “ADVANCED ROTATING TENSION LATCH,” filed Jan. 27, 2021, the entirety of all of which are incorporated herein by reference.
Rotational Alignment—The rotational position between the Peaks and the Pins. A Rotational Alignment of 0 degrees would mean the Pins and Peaks are rotationally aligned, though not necessarily radially aligned.
Should—This term, as used herein, unless otherwise state, should not be construed as “must”, but otherwise construed as “can” or “could”.
Standard Counter Height—This is the typical vertical distance between a Peak that is not offset, and the First Upper Vertical Limit or the Second Upper Vertical Limit, whichever is greater.
Swappable Battery Drone or Swappable Drone—A drone that has at least one battery that can be exchanged at a Swap Station.
Swap Station—A Base Station that allows swapping of batteries and charges batteries that are not in use.
Swinging—When the Hook swings within the Latch while it is at the Lower Vertical Limit. This might only be an issue for configurations with only two Pins.
Switch—For the purposes of this explanation, this is often a push-button (e.g., electronic) switch that is normally open. Different kinds of switch logics can be used.
Switch Activation Distance—The distance the button has to travel on a Switch to engage.
Switch Actuation Force—The force required to depress the Switch button.
Switch Array—Multiple Switches configured to, among other things, provide additional reliability. The array may be in series, so that all need be activated for the circuit to close. However, the Switch Array can be in parallel, or can each have its own logic output if desired.
Switch Depression Distance—The distance the button can travel without bottoming out.
Topping Out—When the Inner Bearing is pushed upwards to its limit. This may happen when the Pins are at an Upper Vertical Limit and push upwards on the Latch. This could trigger the Engagement Sensor. However, Topping Out can also happen on Jamming and Peak Sticking, which could also trigger the Engagement Sensor.
Uptime—The percentage of time in a drone's Work Cycle that it is in Active Mode.
Vertical Limits—Limits within the pick-and-place system that limit vertical movement of the pins. This may include the First and Second Upper Vertical Limit and the Lower Vertical Limit.
Work Cycle—The full cycle of Drone Active Mode to Drone Return Mode to Drone Charge or Swap Mode to Drone Return Mode and back to Drone Active Mode.
Worst Case Hook Offset—This is where the Hook's Pins are both touching the LCD. This gives the maximum offset between the central axis of the Hook and Latch.
Yaw—Rotation of the drone about the vertical axis.
Hook Container—A container with integrated pins (either into the lid/cap or the housing) structured such that the container acts like a Hook in relation to a pick-and-place system.
Tether—A set of at least one cable, string, chain, etc. used to attach a pick-and-place system to a drone. This could use a pulley system.
Winch—A device used to retract or extend a Tethered pick-and-place system or other hook device.
Nest—A reinforced portion of the Latch at or near the Lower Vertical Limit for holding the pins. It could also be a separate portion on the latch that extends radially inwards (in a female latch configuration) and allows a different portion of the hook to rest on it, in place of or in addition to the pins resting at the Lower Vertical Limit.
Lug—The portion of the hook that rests inside the Nest.
Chain Delivery—A system of delivering a payload where one Drone transports a payload from an origination point to a secondary point. Another Drone (or possibly the same recharged Drone) transports the payload to another point, and so on, until it reaches its final destination.
Secondary Catch—A second set of at least one locking component that would prevent disengagement of the Hook from the Latch if the Pins or Lower Vertical Limit failed.
Double-Action Battery Exchange Robot—A robotic Base Station that can move batteries in at least two directions. It can move batteries vertically upwards, and it can move them in an arc, or a line. This allows the robot to use the latch system to remove and place batteries with vertical reciprocating motions into a Drone or into a charger.
Hook Anti-Tilt Rib—A rib on the Hook extending radially outward and mostly perpendicular to the Pins. The rib is long enough to contact or nearly contact interior surfaces on the LCD. These ribs could prevent swaying with the Latch is engaged.
Latch Anti-Tilt Rib—A Rib on the Latch extending radially inward on the cam portions (not the channels) and mostly perpendicularly aligned with the Lower Vertical Limits. The rib protrudes inward enough to contact or nearly contact some portion of the hook to prevent swaying when the latch is engaged.
Box Hook—A cardboard, paper, or similar type of box that is folded and/or glued together and includes a built in Hook.

Turning to FIGS. 1 through 5, illustrated are various different views of different embodiments of a hook container 101, 201, 301, 401, 501 designed, manufactured and/or operated according to one or more embodiments of the disclosure. A hook container 101, 201, 301, 401, 501 according to one or more embodiments of the disclosure could be used as a hook to reduce cost and complexity. A hook container 101, 201, 301, 401, 501 according to one or more embodiments of the disclosure could use the latch and pin features during automated filling and assembly.

Turning to FIGS. 6 through 11, illustrated are various different views of a pick-and-place system 600, 700, 800, 900, 1000, 1100 employing more or more of the hook containers 101, 201, 301, 401, 501, designed, manufactured and/or operated according to one or more embodiments of the disclosure.

Turning to FIGS. 12A through 12D, illustrated are various different views of an automated filling and assembly system 1200, which could employ one or more of the pick-and-place systems and/or hook containers, designed, manufactured and/or operated according to one or more embodiments of the disclosure. In the illustrated embodiment, the automated filling and assembly system 1200 includes a conveyor 1210 having a movement direction 1220 and one or more engagement features 1225, an empty container placement device 1230 (e.g., robot) for placing one or more empty containers 1235, one or more dispensers 1240 for placing product within the one or more empty containers 1235, a cap replacement device 1250 (e.g., robot) and a completed container removal device 1260 (e.g., robot) for removing one or more completed containers 1265. In at least one embodiment, a single device may place, fill, cap and remove the one or more containers. In at least one embodiment, the one or more hook containers (e.g., similar to the hook container 101, 201, 301, 401, 501 disclosed above) could move along a conveyor and use features in their container to hold it in place, as shown. For example, the one or more engagement features 1225 could have a geometric shape that matches with a geometric shape in the one or more hook containers to more accurately hold and fix the one or more containers for a drone to pick it up, and for after landing. The one or more containers, in at least one embodiment, could be thermally insulated, and furthermore could also include space for dry ice, or some other coolant, or a heated material. As shown in FIGS. 1 through 5, the one or more containers could include pins could on the cap or on the container housing.

In one or more embodiments, drones use winches to lift their cargo and to lower it at the destination. The present disclosure has recognized that the ascension of the payload could be assisted by the drone descending while it is winching in the cargo. In one or more embodiments, this relieves the winch actuator of some of the load. For example, the drone could use a tether to engage a payload, and then fly vertically upwards approximately the length of the tether. Then it could descend while winching, to assist the winch motor. This process could save time and energy.

Turning to FIG. 13, in one or more embodiments, a container 1300 (e.g., box) can be formed out of one or more pieces of cardboard, cardstock, paper, etc. to form an enclosure with an integrated hook. The hook can fold together, and it could even use the hook portion to close it as shown in the example, by running it through slits. In one or more embodiments, the hook portion could be reinforced at the pin location with metal, glue, stronger cardboard, plastic, or some other material. The pin area could be folded over and glued for added strength.

Turning to FIG. 14, illustrated is one embodiment of a box pattern 1400 that might be used to form a container, such as the container 1300 of FIG. 13. As shown, the box pattern 1400 includes a central portion 1410, as well as a plurality of ears 1420a, 1420b, and a hook portion 1430 extending therefrom. In at least on embodiment, the hook portion 1430 includes a pin 1435 formed therein. The box pattern 1400, in the illustrated embodiment, further includes one or more slits 1440, for example to accept the hook portion 1430 to close the enclosure when the box pattern 1400 has been folded to form the enclosure. In at least one embodiment, the box pattern 1400 includes one or more perforations and/or indentions 1450 to assist in folding.

In one or more embodiments, the hook could be attached to a package by trapping it down with a label, possibly a shipping label, thereby providing a label trap. In at least one other embodiment, an adhesive material such as tape may simple be used. The hook could be attached to a package by using a puncturing portion of the hook base to puncture the package, and then a twisting or snapping action to anchor it.

In at least one embodiment, the latch could have arms that extend radially outward and engage with a secondary attachment point on a container with an attached/integrated hook, thereby providing a secondary catch. These arms would rotate to align to engage properly based on the rotational alignment of the latch, but could provide a strong attachment point and a secondary catch.

In at least one embodiment, the device could include an automated hook removal. For example, a payload with a hook could be lifted and positioned proximate a tool used to remove the hook and drop the payload. Because the latch holds the hook in a known vertical position, it will be able to vertically align the hook with the removal tool. If rotational alignment is necessary, features on the hook or on the latch could be moved into an alignment jig on the tool. The removal tool could use heat to melt the hook, or a specifically weakened portion of the hook. Alternatively, it could simply cut it or shear it, again, possibly at a designated part of the hook that is pre-weakened for removal.

The present disclosure has further recognized that various different nest and 1 μg configurations may provide in many circumstances improved results when using a pick-and-place system according to one or more embodiments of the disclosure. Turning to FIGS. 15A through 15D, illustrated is an improved hook 1500 designed, manufactured and/or operated according to one or more embodiments of the disclosure. The hook 1500, in one or more embodiments, includes an elongated member 1510 having a first end 1520a and a second end 1520b. In the illustrated embodiment, the hook 1500 additionally includes two or more pins 1530 coupled proximate the first end 1520a of the elongated member 1510 (e.g., each at a right angle to the elongated member 1510). The term “proximate,” as used with regard to the two or more pins 1530, means that the two or more pins 1530 are located more near the first end 1520a than the second end 1520b. In the embodiment of FIGS. 15A through 15D, the hook 1500 includes only two pins 1530, nevertheless other embodiments may exist wherein the hook 1500 includes three or more pins 1530.

The hook 1500 of FIGS. 15A through 15D, in one or more embodiments, additionally includes one or more elongated lugs 1540 that are positioned parallel with the elongated member 1510 between the two or more pins 1530 and the second end 1520b. In one or more embodiments, the one or more elongated lugs 1540 are attached to the elongated member 1510 proximate the two or more pins 1530. In another embodiment, the one or more elongated lugs 1540 are attached to one of the two or more pins 1530 proximate the elongated member. In yet another embodiment, the one or more elongated lugs 1540 are attached to the elongated member 1510 and one of the two or more pins 1530. In the illustrated embodiment, the hook 1500 includes only two pins 1530 and two elongated lugs 1540, each of the two elongated lugs 1540 attached to the elongated member 1510 and one of the two pins 1530.

With reference to FIG. 15B, the one or more elongated lugs 1540 have a first end 1540a proximate the two or more pins 1530 and a second end 1540b distal the two or more pins 1530, and further wherein the second end has a curved outer surface 1550. For example, in the embodiment of FIG. 15B, the one or more elongated lugs 1540 have an arced outer surface 1550, such as a convex surface.

Turning to FIGS. 16A through 16G′, illustrated are various different views of a latch 1600 designed, manufactured and/or operated according to one or more embodiments of the disclosure. The latch 1600, in the illustrated embodiment, includes a lug nest 1610. The lug nest 1610, in one or more embodiments, includes a curved inner surface 1620. For example, in the embodiment of FIGS. 16D and 16E, the lug nest 1610 has an arced inner surface 1620, such as a concave surface or a U-shaped surface. The latch 1600 of FIGS. 16A through 16E additionally includes a lug ramp 1630. The lug ramp 1630, in one or more embodiments, has an angled inner surface 1640, such as a V-shaped inner surface that may be used for tilt correction. The latch 1600, in the embodiment of FIGS. 16A through 16G′, may additionally include two or more peaks 1650, as well as an approximate longest vertical gap 1660.

In one or more embodiments, the nest and lug configuration provides anti-tilt support. In at least one embodiment, the elongated lug can fit within a similarly long curved channel (e.g., U-shaped channel or concave channel) in the nest. Since the hook is supported by the nest when the latch is engaged, it can resist tilting and swaying. The elongated lug can also help increase stiffness, as described below. Moreover, for some uses-cases, the lug can fit snuggly (e.g., interference fit) into the nest so that it prevents tilting and requires added force to release. This can help secure a payload, especially lighter payloads. A sticky pick-up surface, or some kind of grips could hold the package slightly as it is lifted. Additionally, even without the long curved channel in the nest, the lug mating in the nest, coupled with the pin mating in a channel or at the lower limit can prevent rotation. This may potentially put unwanted strain on the pin, which might be a tradeoff necessary in certain situations.

The nest and lug configurations may also act as a connection lug. For example, in cases where the hook may want to connect to the latch or operator, like with wire leads, the lug could mate a connector with the nest. This could be particularly useful with swappable batteries. The lug could connect to the nest using barrel connectors (e.g., or other types of electrical connectors). This could also assist in anti-tilt and it could help hold the swappable battery in place.

The nest and lug configurations may also allow for increased strength possibilities. For example, use of different materials between the lug and the pin are possible. Additionally, the nest and lug configuration allows for different profiles/shapes for more strength, for example without compromising the ability of the pins to slide through the contours. This includes having a longer lug to increase stiffness, without requiring the contours to be larger. Moreover, the pin can be much smaller since it does not bear the load. Additionally, the lug can be held closer to the central axis of the hook, and thus could limit the bending of the pins. This is particularly important when it is ideal for the shaft of the hook to be as small in radius as possible.

There are certain considerations for implementing a nest and lug configuration according to one or more embodiments of the disclosure. For example, one consideration is nest or lug snag prevention. A lug in a system without an anti-tilt pin could tilt while the pin(s) are in the general vicinity of an upper vertical limit. If the lug is short enough that one lug could tilt into a contour gap, it could snag and prevent the latch from working properly. In such a system, ensuring that the lug and pin combine to be longer than the largest gap in the contours will prevent this kind of snagging. However, the largest point-to-point gap will usually be horizontal, but the lug cannot be oriented horizontally within these gaps because the hook cannot tilt that much before the shaft/stem contacts the bottom areas of the latch. Therefore, it might be more optimal to simply ensure the lug is longer than (or nearly as long as) the largest (mostly) vertical gap in the upper contour portion.

It is also important that Y be sufficiently large with respect to the gaps in the contours. If Y is too small, the hook can tilt with respect to the latch and the bottom of the lug can contact a point on the contours below the pin, jamming the latch. The two areas of concern are the areas below the two upper vertical limits. D is the lowest point on the contour surface opposite the first upper vertical limit, and the distance between these points is X. E is the lowest point on the contour surface opposite the second upper vertical limit and the distance between them is Z. X and Z should be at most Y plus the diameter of the pin (or, in the case that the pin is not circular, the vertical height of the pin). This will ensure that the lug extension of the hook cannot tilt into the contour space, no matter how the hook tilts within the latch.

It is beneficial for the nest to include ramps that guide the lug into the nest channel. These ramps should be mostly parallel to the adjacent contours of the latch that guide the pin towards the lower vertical limit. This ensures that if the hook sways as the pin reaches the lower vertical limit, the lug does not snag on the walls of the nest, but is guided into its resting place. It is beneficial for the nest to include ramps that guide the lug into the nest channel. These ramps should be mostly parallel to the adjacent contours of the latch that guide the pin towards the lower vertical limit. This ensures that if the hook sways as the pin reaches the lower vertical limit, the lug does not snag on the walls of the nest, but is guided into its resting place.

There are two optimizations to the geometries that can be made to ensure the lug does not catch on the outside of the nest ramps and that the ramps always guide the lug into the nesting position. First, the minimum distance (R) from point C (the lowest point on the contour leading to the channel towards the first lower vertical limit) to any point on the ramp should be at least Y of the hook. Second, the line made by drawing a line from point C to point J (the outer-most point of the nest ramp on the side closest to point C) forms an angle with respect to vertical, H. This angle H should be greater than angle I, which is the angle with respect to vertical of maximum tilt of the hook with respect to the latch with the pin is at point C. This is generally limited by the bottom edge of the latch, contacting the diameter of the shaft of the hook. Note that these angles are of lines projected on a plane centered on the latch and normal to the nest. With both of these inclusions, the lug will never get caught on the outside of the nest ramps, no matter how the hook is tilted with respect to the latch. Of note, these illustrated drawings are section views, thus the angle in reality may different than they appear in the drawings.

It is beneficial, in one or more embodiments, to include a mostly vertical channel for the pin that leads to the lower vertical limit. This channel should be long enough so that when the pin reaches the entrance to the channel, the lug is still vertically spaced from the walls of the nest. As the pin enters the channel, the lug will enter the nest. It is sometimes best if the lug fully stops at the nest before the pin actually reaches the lower vertical limit. In fact, the nest and lug can be used in place of the lower vertical limit completely, so that the vertical channel for the pins extends to or even past the nest. This prevents the lug from snagging on the lower vertical limit of the contours for the pin if it is slightly tilted as it descends.

The peaks of the latch, in one or more embodiments, should ensure that the hook is sufficiently rotated with respect to the lugs before the nest and the lugs contact. It is therefore beneficial for the peaks to be at least somewhat vertically aligned with the lower vertical limit and/or the nest. It might also be beneficial for the peaks to be vertically broken out and extended from the rest of the contour (e.g., which means it would have substantially vertical walls) so as to ensure the hook and latch are rotated sufficiently to avoid the lug contacting the nest.

In one or more embodiments, the nest can be shaped to prevent contact with the lug on entry. In one or more embodiments, Y is the vertical distance from the bottom of the pin to the bottom of the Lug. In one or more embodiments, point A is the point on the peak contour where it is vertically distanced from the nest by the distance Y and is on the side of the peak that leads towards the entry region of the latch contours. In one or more embodiments, point B is the point on the peak contour where it is vertically distanced from the nest by the distance Y and is on the side of the peak that leads towards the exit region of the latch contours. In one or more embodiments, each peak has a point A and a point B. In a two-latched system, one set could be points A and B, and the opposite peak would be A′ and B′. A′ and B′ could be on the offset peak, for example.

When looking up into a female latch, one could draw lines from A to A′ and B to B′ which would intersect at (or nearly intersect at) the central axis of the latch. The regions created by the intersecting lines between A and B and A′ and B′ should not contain the portion of the nest that extends radially inwards from the ID surfaces of the Latch (in a female configuration). Otherwise, the nest could interfere with the lug. If the radial extension from the central axis of the hook to the lug is less than the inner radius of the latch, it is possible that some of the portion near the ID surfaces of the latch could extend out of this region, given that some feature (for example, the pins contacting a radial surface of the latch) prevents the lug from touching that portion of the nest.

Turning to FIGS. 17A through 17E, illustrated are different views of one embodiment of a pick-and-place system 1700, having a hook 1710 and latch 1720 designed, manufactured and/or operated according to one or more embodiments of the disclosure. The hook 1710, in one or more embodiments, may be similar to the hook 1500 of FIGS. 15A through 15E. Similarly, the latch 1720, in one or more embodiments, may be similar to the latch 1600 of FIGS. 16A through 16E. The embodiment of FIGS. 17A through 17E may be used to help illustrate the engagement between the hook 1710 and the latch 1720.

Turning to FIGS. 18A through 18C, illustrated is an alternative embodiment of a latch 1800 designed, manufactured and/or operated according to one or more embodiments of the disclosure. Previous configurations of a bearing for the latch show a latch that is fixed to an inner bearing, and an outer bearing that is fixed to the robot. A reverse configuration can also be used and can have additional benefits. An inner bearing could be fixed (or somewhat fixed) to the robot, and the outer bearing can be part of or fixed to the latch. Features such as anti-spin teeth, floating bearing features, contact switches or sensors, etc. can be included in this system, just as in the original system. Some benefits are that sensors can be incorporated directly into the inner bearing. These could be optical sensors (IR sensors), or other sensors that can be used to locate the position of the hook and/or pins. For example, a camera could be nested in the inner bearing, which not only could help in locating the hook/pins/payload, but could be used when a camera that is facing the direction of the latch is helpful. A drone, for example, could use this as a downwards facing camera. It might be helpful to also include a light source along with the camera so that the camera can see positions of the hook/pins. Windows in the latch could also allow ambient light to enter. A drone could also use a distance sensor (such as LIDAR or SONAR) in the inner bearing. This could further help a drone detect the position of the hook/pins, and could be used for other applications where the hook.

In the illustrated embodiment of FIGS. 18A through 18C, a reversed bearing 1810 is provided. The reversed bearing 1810, in one embodiment, includes a fixed member 1820, which could be fixed to a robot/drone/arm. The reversed bearing 1810, in one or more embodiments, may additionally include a routing hole 1830 (e.g., a cable/wire routing hole). The reversed bearing 1810 may additionally include a sloped inner bearing surface 1840 and a sloped outer bearing surface 1850 (e.g., fixed to the latch body 1870), as well as in certain embodiments a sensor or camera 1860.

Turning to FIGS. 19A through 19D, illustrated are various different views of a centering cone 1900 designed, manufactured and/or operated according to one or more embodiments of the disclosure. The centering cone 1900, in the illustrated embodiment, includes a cone shaped enclosure 1910 having an aperture 1920 at one end. The centering cone 1900, in the illustrated embodiment, may additionally include an exit channel and/or exit slit 1930. It may sometimes be advisable to adjust the center of mass of the latch. One example is when the latch is intended to fall through the centering cone 1900 when attached to a tether. In this case, it may be helpful (e.g., ideal) for the center of mass of the latch to be as low (close to the entry) as possible. This will help the latch favor the correct orientation as it contacts and slides down the cone and into the centering channel. The center of mass can be lowered by adding material to the bottom or removing material from the top. The center of mass can also be lowered by using denser materials or adding weight(s) to the lower portion, like the bell.

In one or more embodiments, it is helpful for the outer diameter of the latch to be close in diameter (but always smaller in diameter) to the of the centering channel for better possible centering. However, since the latch may have a bell, and a solid construction may be heavy or create manufacturing difficulties, it might be better to include ribs that extend radially outwards to create an effective outer diameter that is close to the diameter of the centering channel. Furthermore, as the latch slides down the cone towards the centering channel, it should tilt towards being axially vertical to enter a narrow channel. Because of this, the center channel diameter cannot be equal to the outer diameter of the latch, otherwise, it will get stuck. Furthermore, it is beneficial to include a radius in the slope, rather than a sharp corner, so that the latch can gradually tilt towards vertical, and thus enter a smaller centering channel than it otherwise could. In one or more embodiments, the profile of the cone is not a simple circle with a slot. This could snag the tether as the drone tries to exit if it does not exit in the perfect direction. Rather, the profile could (e.g., should) slope towards the exit so that the tether can slide along the inner surfaces of the cone and out the exit. Thus, in one or more embodiments, is cone slit is sloped for the latch to slide down, and furthermore the opening could be big enough for a mechanical arm to use the latch system to slide a package into place, then lift out of the aperture.

In one or more embodiments, a reverse container with nest and lug is provided. The following description will refer to a hook container that is used as a battery for the attaching robot. However, most of the elements of the reverse container description below apply to any hook container system, not just a battery. The battery, which is a reverse container, could have a hole with chamfers on either side for an alignment pin. The alignment pin on the robot/drone could have a spring loaded plunger that can server multiple purpose. The plunger could help force the connectors together. It could also prevent significant movement between the battery and the robot during operation. It could also allow the robot to change orientation with respect to gravity since the spring plunger can force the battery into place. The plunger could have a limiter so that the spring system provides high load a maximum extension of the plunger. This also reduces the required travel of the spring. In order for a robot to have the battery removed and replaced by a simple vertically reciprocating platform, the robot should be raised above the system that moves the platform between the charging station and the robot station. This helps guarantee that the drone can land in any yaw orientation and that its landing gear will not interfere with the movement of the batteries. This means that the battery swap station may need a platform with an aperture for the battery and battery platform to raise through.

Turning to FIGS. 20A through 20E, illustrated are various different views of a battery system 2000 according to one or more embodiments of the disclosure. The battery system 2000, in the illustrated embodiment, includes a hook container battery 2010. The hook container battery 2010, in one or more embodiments, includes a connector 2020 for a robot on the battery, an alignment hole 2030 and one or more alignment chamfers 2040. The battery system 2000, in the illustrated embodiment, further includes a hook system 2050 (e.g., such as a robot), the hook system 2050 include two or more hook pins 2060. In at least one embodiment, an aperture 2065 for the hook system 2050 needs to be large enough to accommodate lugs in any orientation. Positioned between the hook container battery 2010 and the hook system 2050, in one or more embodiments, are a plunger 2070 and a spring 2080 for pushing the plunger down.

Additionally provided in the disclosure is a pick up fixed and drop off tethered system. It could be helpful to have a system that uses a fixed, or bearing joined latch to pick up a payload, and then a retractable tether to drop-off the payload. This can be achieved using the latch system by fixing the bearing system to a retractable tether. When the tether is pulled into the robot or drone, it can lock in place and be used for pick up. The tether can then lower the bearing/latch assembly with the package for drop off. This is helpful when picking up with a tether is difficult due to wind or other factors, but when a tethered drop-off is still preferred.

With reference to FIG. 21A, an attachment 210 of the positioning arm 160 (not shown in these views) places the male latch member 120 vertically proximate the female latch member 110. The first pin 112 is randomly positioned with respect to the workpiece 150 and the male latch member 120, as would be the case in a manufacturing production line. In these figures, the first pin 112 is represented by its cross section as a small circle. The central axis 124 is approximately aligned with a center of the central aperture 111. The male latch member 120 is aligned with, but not in contact with, the female latch member 110 at this point. The female latch member 110 is fixed with respect to the workpiece 150 in this example. A vertical downward force F_{M} is applied to the male latch member 120. In one embodiment, this downward force F_{M} may be applied by the positioning arm 160 (not shown) through the attachment 210. In this embodiment, the male latch member 120 is free to rotate as necessary around the central axis 124 even as the downward force F_{M} is applied.

In an alternative embodiment, the male latch member 120 may be positioned by a flexible attachment 120 such as a cable (not shown). In that embodiment, gravity acting on the male latch member 120 may be used as a force to latch and unlatch the male latch member 120 to the female latch member 110. Of course, one who is of skill in the art will realize that tool tolerances for a gravity-operated device must be carefully considered for reliable operation.

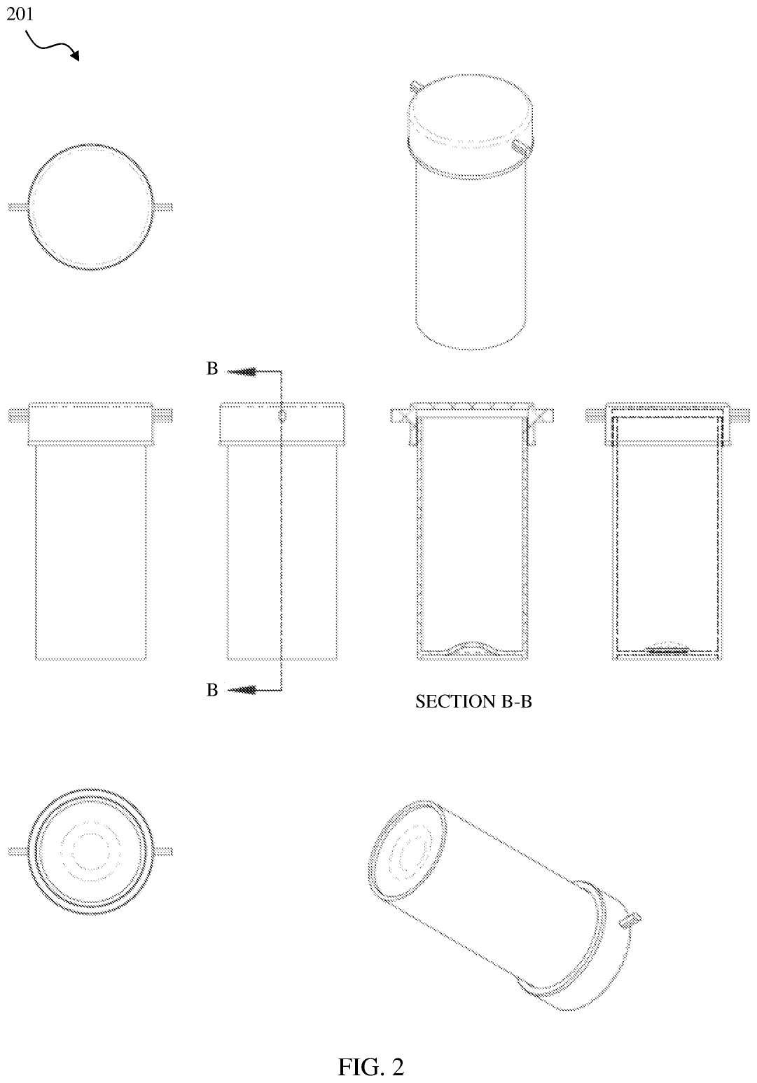

FIG. 21B shows the male latch member 120 advanced vertically downward toward the central aperture 111 with the chamfered end or truncated cone 128 assisting in correcting for non-alignment of the central aperture 111 and the central axis 124. In the illustrated embodiment, the first pin 112 contacts a point 201 on the third irregular surface 134 and the male latch member 120 rotates counter-clockwise R_{cc} (when viewed from above) or left to right as in FIG. 2B as the male latch member 120 advances downward toward the female latch member 110. As the male latch member 120 further advances toward the female latch member 110 and rotates, the first pin 112 moves toward a point 202 on the third irregular surface 134.

FIG. 21C shows the male latch member 120 rotated and advanced so that the first pin 112 is at the point 202 on the third irregular surface 134. The male latch member 120 continues to advance toward the female latch member 110, but ceases rotation for a moment, as the first pin 112 moves toward a point 203 on the first irregular surface 131.

FIG. 21D shows the male latch member 120 advanced so that the first pin 112 is at the point 203 on the first irregular surface 131. The male latch member 120 continues to advance toward the female latch member 110, but now rotates clockwise R_{cw} from above (right to left in the FIG.), and the first pin 112 moves toward a point 204 on the first irregular surface 131.

FIG. 21E shows the male latch member 120 advanced so that the first pin 112 is at the point 204 on the first irregular surface 131. The male latch member 120 is at its farthest advance toward the female latch member 110 until the two members lock in tension. The male latch member 110 force F_{M} now reverses to an upward vertical force so that the male latch member 120 moves upward relative to the female latch member 110 and the first pin 112 moves toward a point 205 on the second irregular surface 132.

FIG. 21F shows the male latch member 120 withdrawn so that the first pin 112 is at the point 205 on the second irregular surface 132. The male latch member 120 continues to withdraw from the female latch member 110, but now rotates clockwise R_{cw} from above (right to left in the FIG.), and the first pin 112 moves toward a point 206 on the second irregular surface 132.

FIG. 21G shows the male latch member 120 withdrawn so that the first pin 112 is captured at the point 206 on the second irregular surface 132. Point 206 includes a concavity configured to capture the first pin 112 in tension between the female latch member 110 and the male latch member 120. The male latch member 120 and the female latch member 110 are now locked in tension and will move vertically, or alternatively horizontally, as a single unit so long as there is continuous upward force F_{M}. The latched condition may be termed temporary because the pick-and-place system 100 (e.g., rotating tension latch) is intended for the limited amount of time necessary to reposition the workpiece.

FIG. 21H shows the male latch member 120 withdrawn vertically with the female latch member 110 coupled thereto as well as workpiece 150. The first pin 112 remains captured in tension at point 206. Therefore, workpiece 150 can be relocated as necessary to the next station on the assembly line.

FIG. 211 shows the male latch member 120 located so that the workpiece 150 is at the next station of the assembly line. The workpiece 150, female latch member 110 and male latch member 120 are lowered until the workpiece 150 is in position. At that time, the female latch member 110 and the workpiece resist further movement, and a downward vertical force F_{M} may be applied to the male latch member 120 releasing tension on the first pin 112. This force F_{M} causes vertical motion of the male latch member 120 relative to the female latch member 110 and places the first pin 112 at a point 207 on the first irregular surface 131. Continued downward force F_{M} causes clockwise rotation R_{cw} of the male latch member 120 and movement of the first pin 112 toward a point 208 on the first irregular surface 131. This, in one embodiment, unlocks the male latch member 120 from the female latch member 110.

FIG. 21J shows the male latch member 120 advanced so that the first pin 112 is at the point 208 on the first irregular surface 131. Reversing the vertical force F_{M} causes the male latch member 120 to move vertically relative to the female latch member 110 and the first pin 112 moves toward a point 209 on the second irregular surface 132.

FIG. 21K shows the male latch member 120 withdrawn from the female latch member 110 so that the first pin 112 is at the point 209 on the second irregular surface 132. Continued withdrawal of the male latch member 120 by upward force F_{M} causes the male latch member 120 to rotate clockwise R_{cw} as the first pin 112 proceeds toward a point 210 on the second irregular surface 132.

FIG. 21L shows the male latch member 120 withdrawn sufficiently from the female latch member 110 that the first pin 112 is at the point 210 on the second irregular surface 132.

Continued withdrawal of the male latch member 120 causes the male latch member 120 to separate completely from the female latch member 110.

FIG. 21M shows the male latch member 120 completely withdrawn from the female latch member 110.

Turning now to FIGS. 21N and 21P, illustrated is a sectional view of the male latch member 120 of FIGS. 21A-21M. FIG. 21N illustrates the various different surfaces (e.g., illustrated with the letter S) and vertical limits (e.g., illustrated with the letter L) of the male latch member 120, and FIG. 21P illustrates the various different transition points (e.g., illustrated with the letter T) and channels (e.g., illustrated with the letter C) of the male latch member 120.

FIGS. 21N and 21P, and the surfaces, vertical limits, transition points, and channels, will be used to further discuss the path that a pin might travel as a male latch member and female latch member would engage and disengage one another. Similarly, the surfaces, vertical limits, transition points, and channels of different paths a pin might take may be delineated from one another by using a combination of letters and numbers (e.g., S1a, T1, C1, T1), a combination of letters and numbers with a single prime symbol (e.g., S1a′, T1′, C1′, T1′), a combination of letters and numbers with a double prime symbol (e.g., S1a″, T1″, C1″, T1″), etc. For example, in a three pin design, a first pin might follow a path delineated without any prime symbol, a second pin might follow a path delineated with a single prime symbol, and a third pin might follow a path delineated with a double prime symbol. Traditionally, the different paths of a given design are substantially identical, if not entirely identical, to one another.

For the purpose of the following discussion, it will be assumed that the male latch member 120 is configured (e.g., allowed) to rotate clockwise and counter-clockwise (e.g., with respect to the female latch member) as may be necessary to operate. In an alternative embodiment, the female latch member might be configured (e.g., allowed) to rotate clockwise and counter-clockwise (e.g., with respect to male latch member) as may be necessary to operate.

In yet another embodiment, each of the male latch member and female latch member may be configured (e.g., allowed) to rotate freely with respect to each other.

It should be noted that while the embodiment of FIGS. 21N and 21P illustrate the male latch member 120 having the channels that the pin from the female latch member would engage, the same theory could apply if the female latch member were to have the channels that the pin from the male latch member would engage. Accordingly, the present disclosure should not be limited to one design or the other.

In operation, a pin would typically encounter the second portion 126 either to the left or right of the transition point T1. If the pin were to encounter the upwardly slanting surface Sla of the second portion 126, it would cause the male latch member 120 to rotate counter-clockwise (when viewed from above) and thus the pin would slide upwards until it reaches the transition point T2. After reaching the transition point T2, the pin would travel upward to encounter the upwardly slanting surface S2 of the first portion 125. The upwardly slanting surface S2, in the embodiment shown, slants in an opposite direction as the upwardly slanting surface Sla. When the pin encounters the upwardly slanting surface S2, it causes the male latch member 120 to rotate clockwise (when viewed from above) and thus the pin would travel through the channel C1 and slide upwards until it reaches the vertical upper limit L1. Thus far, the pin has traveled to the vertical upper limit L1 by way of a relative downward force (e.g., an intentional force, gravitational force, etc.) upon the male latch member 120. The term “relative” is used in this instance as the force might be placed upon the male latch member, female latch member, or both of the male latch member and female latch member.

At this point, the pin is locked in the vertical upper limit L1 position until the relative downward force subsides. Exchanging the downward force for an upward force, the pin would travel down the surface S3 (e.g., substantially vertical surface S3 in one embodiment) to the transition point T3. At the transition point T3, the pin would head toward the downwardly slanting surface S4 of the second portion 126. As the pin encounters the downwardly slanting surface S4, it would cause the male latch member 120 to rotate clockwise (when viewed from above) and thus the pin would slide downward until it reaches the vertical lower limit L2. At this point, the female latch member 110, as well as anything attached to it, could be picked up by way of the pin being held in the vertical lower limit L2. This would be considered the “pick” of the “pick and place” process.

The pin may be released from the vertical lower limit L2 of the male latch member 120 by putting relative downward force (e.g., an intentional force, gravitational force, etc.) upon the male latch member 120. As downward force is applied to the male latch member 120, the pin travels up the upward slanting surface S5 (e.g., substantially vertical upward slanting surface S5 in one embodiment) until it encounters the transition point T4. After reaching the transition point T4, the pin would travel upward through the channel C2 to encounter the upwardly slanting surface S6 of the first portion 125. The upwardly slanting surface S6, in the embodiment shown, slants in an opposite direction as the upwardly slanting surface S1A, and in the same direction as the upwardly slanting surface S2. In the embodiment shown, the upwardly slanting surface S2 and upwardly slanting surface S6 are substantially, if not completely, parallel with one another. When the pin encounters the upwardly slanting surface S6, it causes the male latch member 120 to rotate clockwise (when viewed from above) and thus the pin would slide upwards until it reaches the vertical upper limit L3.

At this point, the pin is locked in the vertical upper limit L3 position until the relative downward force subsides. Exchanging the downward force for an upward force, the pin would travel down the surface S7 (e.g., substantially vertical surface S7 in one embodiment) to the transition point T5. At the transition point T5, the pin would head through the channel C3 toward the downwardly slanting surface S8 of the second portion 126. As the pin encounters the downwardly slanting surface S8, it would cause the male latch member 120 to rotate clockwise (when viewed from above) and thus the pin would slide downward past the transition point T6 until it reaches the transition point T7. When the pin reaches the transition point T7, the female latch member 110, as well as anything attached to it, would disengage from the male latch member 120. This would be considered the “place” of the “pick and place” process.

In contrast, to that described above, the pin might first encounter the upwardly slanting surface S1b of the second portion 126, which would cause it to take an entirely different path. For example, if the pin were to encounter the upwardly slanting surface S1b, it would cause the male latch member 120 to rotate clockwise (when viewed from above) and thus the pin would slide upwards until it reaches the transition point T7. After reaching the transition point T6, the pin would travel upward through the channel C4 to encounter the upwardly slanting surface S2′ of the first portion 125. The upwardly slanting surface S2′, in the embodiment shown, slants in the same direction as the upwardly slanting surface S1b. When the pin encounters the upwardly slanting surface S2′, it causes the male latch member 120 to rotate clockwise (when viewed from above) and thus the pin would slide upwards until it reaches the vertical upper limit L1′. Thus far, the pin has traveled to the vertical upper limit L1′ by way of a relative downward force (e.g., an intentional force, gravitational force, etc.) upon the male latch member 120.

At this point, the pin is locked in the vertical upper limit L1′ position until the relative downward force subsides. Exchanging the downward force for an upward force, the pin would travel down the surface S3′ (e.g., substantially vertical surface S3 in one embodiment) to the transition point T3′. At the transition point T3′, the pin would head toward the downwardly slanting surface S4′ of the third portion 127. As the pin encounters the downwardly slanting surface S4′, it would cause the male latch member 120 to rotate clockwise (when viewed from above) and thus the pin would slide downward until it reaches the vertical lower limit L2′. At this point, the female latch member 110, as well as anything attached to it, could be picked up by way of the pin being held in the vertical lower limit L2′. This would again be considered the “pick” of the “pick and place” process.

The pin may be released from the vertical lower limit L2′ of the male latch member 120 by putting relative downward force (e.g., an intentional force, gravitational force, etc.) upon the male latch member 120. As downward force is applied to the male latch member 120, the pin travels up the upward slanting surface S5′ (e.g., substantially vertical upward slanting surface S5 in one embodiment) until it encounters the transition point T4′. After reaching the transition point T4′, the pin would travel upward through the channel C2′ to encounter the upwardly slanting surface S6′ of the first portion 125. The upwardly slanting surface S6′, in the embodiment shown, slants in the same direction as the upwardly slanting surface S1b and upwardly slanting surface S2′. When the pin encounters the upwardly slanting surface S6′, it causes the male latch member 120 to rotate clockwise (when viewed from above) and thus the pin would slide upwards until it reaches the vertical upper limit L3′.

At this point, the pin is locked in the vertical upper limit L3′ position until the relative downward force subsides. Exchanging the downward force for an upward force, the pin would travel down the surface S7′ (e.g., substantially vertical surface S7 in one embodiment) to the transition point T5′. At the transition point T5′, the pin would head through the channel C3′ toward the downwardly slanting surface S8′ of the second portion 126. As the pin encounters the downwardly slanting surface S8′, it would cause the male latch member 120 to rotate clockwise (when viewed from above) and thus the pin would slide downward past the transition point T6′ until it reaches the transition point T7′. When the pin reaches the transition point T7′, the female latch member 110, as well as anything attached to it, would disengage from the male latch member 120. This would again be considered the “place” of the “pick and place” process.

As noted in FIGS. 21N and 21P, in one embodiment of the disclosure, if a line along S1a′ is extended (e.g., as shown by the dotted line DL1) it intersects the upwardly slanting surface S2′, as opposed to the channel C3 of the other pin path. Said another way, in the embodiment shown, the dotted line DL1 intersects the upwardly slanting surface S2′ above the transition point T6. This dotted line DL1 indicates the likely path of travel for a given pin. This is designed to assure that a given pin, when travelling along the dotted line DL1, will not engage the wrong channel (e.g., in this instance channel C3). Similarly, if a line along S1b is extended (e.g., as shown by the dotted line DL2) it, in one embodiment, would intersect the upwardly slanting surface S1a′, as opposed to a substantially vertical surface. This is designed to assure that a given pin will not bounce back off of the surface S1a′ into the channel C3, as opposed to ultimately the desired channel C1′.

As further noted in FIGS. 21N and 21P, in one embodiment of the disclosure, the vertical upper limit L3 is vertically higher (e.g., by a distance (D1)) than the vertical upper limit L1, and the vertical upper limit L3′ is vertically higher (e.g., by a distance (D1′)) than the vertical upper limit L1′. In this embodiment, distance D1 and D1′ are substantially identical. Similarly, in the embodiment shown, the vertical upper limit L1 is horizontally spaced from the vertical upper limit L3 by a distance D2, and the vertical upper limit L1′ is horizontally spaced from the vertical upper limit L3′ by a distance D2′. In this embodiment, distance D2 and D2′ are substantially identical. Unique to at least one embodiment of the present design, a horizontal distance D3 separating the vertical upper limit L3 and the vertical upper limit L1′ is different from the distances D2 or D2′. In one embodiment, the distance D3 is greater than each of the distances D2 or D2′. Such a spacing is designed to allow the dotted line DL1 to intersect the upwardly slanting surface S2′, as opposed to the channel C3 of the other pin path, and therefore reduce the likelihood of a given pin engaging the wrong channel.

Turning finally to FIG. 22, illustrated is a summary of one embodiment of autonomous pick-up and drop-off according to one or more embodiments of the disclosure.

Aspects disclosed herein include:

A. A hook, the hook including: 1) an elongated member having a first end and a second end; 2) two or more pins coupled proximate the first end of the elongated member; and 3) one or more elongated lugs positioned substantially parallel with the elongated member between the two or more pins and the second end.

B. A latch, the latch including: 1) a latch member having a central axis and a surface surrounding the central axis, the latch member having a first upper portion and second and third lower portions extending radially from the surface, the second and third lower portions circumferentially spaced from one another and axially spaced from the first upper portion, guide and limit surfaces of the second and third lower portions facing respective guide and limit surfaces of the first upper portion that cooperate to form first and second channels, the first and second channels being similarly shaped, each of the first and second channels having in order a first upwardly sloping path defined by a respective first upwardly slanting guide surface and a first limit surface of the first upper portion, a second downwardly sloping path defined by a respective second downwardly slanting guide surface and a second limit surface of a respective lower portion, and a third upwardly sloping path defined by a respective third upwardly slanting guide surface and a third limit surface of the first upper portion, the first and second channels configured to each receive a pin of a related hook; and 2) a lug nest located proximate the second limit surface of the first channel, the lug nest having a curved inner surface.

C. A pick-and-place system, the pick-and-place system including: 1) a hook, including: a) an elongated member having a first end and a second end; b) two or more pins coupled proximate the first end of the elongated member; and c) one or more elongated lugs positioned substantially parallel with the elongated member between the two or more pins and the second end; and 2) a latch coupleable with the hook, the latch including: a) a latch member having a central axis and a surface surrounding the central axis, the latch member having a first upper portion and second and third lower portions extending radially from the surface, the second and third lower portions circumferentially spaced from one another and axially spaced from the first upper portion, guide and limit surfaces of the second and third lower portions facing respective guide and limit surfaces of the first upper portion that cooperate to form first and second channels, the first and second channels being similarly shaped, each of the first and second channels having in order a first upwardly sloping path defined by a respective first upwardly slanting guide surface and a first limit surface of the first upper portion, a second downwardly sloping path defined by a respective second downwardly slanting guide surface and a second limit surface of a respective lower portion, and a third upwardly sloping path defined by a respective third upwardly slanting guide surface and a third limit surface of the first upper portion, the first and second channels configured to each receive one of the two or more pins of the hook; and b) a lug nest located proximate the second limit surface of the first channel, the lug nest having a curved inner surface.

Aspects A, B, and C may have one or more of the following additional elements in combination: Element 1: wherein the one or more elongated lugs are attached to the elongated member proximate the two or more pins. Element 2: wherein the one or more elongated lugs are attached to ones of the two or more pins. Element 3: wherein the one or more elongated lugs are attached to ones of the two or more pins proximate the elongated member. Element 4: wherein the two or more pins are only two pins, and further wherein the one or more elongated lugs are only two elongated lugs. Element 5: wherein a first of the only two elongated lugs is attached to a first of the only two pins and a second of the only two elongated lugs is attached to a second of the only two pins. Element 6: wherein the one or more elongated lugs have a first end proximate the two or more pins and a second end distal the two or more pins, and further wherein the second end has a curved outer surface. Element 7: wherein the curved outer surface is a convex outer surface. Element 8: wherein the lug nest is a first lug nest, and further including a second lug nest located proximate the second limit surface of the second channel, the second lug nest having a second curved inner surface. Element 9: wherein the latch does not include a third channel or a third lug nest. Element 10: wherein the curved inner surface is an arced inner surface. Element 11: wherein the curved inner surface is a U-shaped inner surface. Element 12: wherein the curved inner surface is a concave inner surface. Element 13: further including a lug ramp coupled to the lug nest such that an elongated lug of a hook may engage the lug ramp prior to nesting in the lug nest. Element 14: wherein the lug ramp includes an angled inner surface leading to the lug nest and configured to assist with tilt correction. Element 15: wherein the angled inner surface is a V-shaped inner surface. Element 16: wherein the two or more pins of the hook are located within the first and second channels of the latch. Element 17: wherein one of the one or more elongated lugs is nested within the lug nest. Element 18: wherein one of the one or more elongated lugs is sufficiently spaced from the one or more pins to prevent the one or more elongated lugs from fitting between the first upper portion and the second or third lower portions. Element 19: wherein one of the one or more elongated lugs is spaced from the one or more pins by at least a maximum straight-line distance from the first limit surface to the second downwardly-sloping guide surface.

Those skilled in the art to which this application relates will appreciate that other and further additions, deletions, substitutions and modifications may be made to the described embodiments.

What is claimed is:

1. A hook, comprising:
an elongated member having a first end and a second end;
two or more pins coupled proximate the first end of the elongated member; and
one or more elongated lugs positioned substantially parallel with the elongated member between the two or more pins and the second end.

2. The hook as recited in claim 1, wherein the one or more elongated lugs are attached to the elongated member proximate the two or more pins.

3. The hook as recited in claim 2, wherein the one or more elongated lugs are attached to ones of the two or more pins.

4. The hook as recited in claim 1, wherein the one or more elongated lugs are attached to ones of the two or more pins proximate the elongated member.

5. The hook as recited in claim 1, wherein the two or more pins are only two pins, and further wherein the one or more elongated lugs are only two elongated lugs.

6. The hook as recited in claim 5, wherein a first of the only two elongated lugs is attached to a first of the only two pins and a second of the only two elongated lugs is attached to a second of the only two pins.

7. The hook as recited in claim 1, wherein the one or more elongated lugs have a first end proximate the two or more pins and a second end distal the two or more pins, and further wherein the second end has a curved outer surface.

8. The hook as recited in claim 7, wherein the curved outer surface is a convex outer surface.

9. A latch, comprising:
a latch member having a central axis and a surface surrounding the central axis, the latch member having a first upper portion and second and third lower portions extending radially from the surface, the second and third lower portions circumferentially spaced from one another and axially spaced from the first upper portion, guide and limit surfaces of the second and third lower portions facing respective guide and limit surfaces of the first upper portion that cooperate to form first and second channels, the first and second channels being similarly shaped, each of the first and second channels having in order a first upwardly sloping path defined by a respective first upwardly slanting guide surface and a first limit surface of the first upper portion, a second downwardly sloping path defined by a respective second downwardly slanting guide surface and a second limit surface of a respective lower portion, and a third upwardly sloping path defined by a respective third upwardly slanting guide surface and a third limit surface of the first upper portion, the first and second channels configured to each receive a pin of a related hook; and
a lug nest located proximate the second limit surface of the first channel, the lug nest having a curved inner surface.

10. The latch as recited in claim 9, wherein the lug nest is a first lug nest, and further including a second lug nest located proximate the second limit surface of the second channel, the second lug nest having a second curved inner surface.

11. The latch as recited in claim 10, wherein the latch does not include a third channel or a third lug nest.

12. The latch as recited in claim 9, wherein the curved inner surface is an arced inner surface.

13. The latch as recited in claim 9, wherein the curved inner surface is a U-shaped inner surface.

14. The latch as recited in claim 9, wherein the curved inner surface is a concave inner surface.

15. The latch as recited in claim 9, further including a lug ramp coupled to the lug nest such that an elongated lug of a hook may engage the lug ramp prior to nesting in the lug nest.

16. The latch as recited in claim 15, wherein the lug ramp includes an angled inner surface leading to the lug nest and configured to assist with tilt correction.

17. The latch as recited in claim 16, wherein the angled inner surface is a V-shaped inner surface.

18. A pick-and-place system, comprising:
a hook, including:
an elongated member having a first end and a second end;
two or more pins coupled proximate the first end of the elongated member; and
one or more elongated lugs positioned substantially parallel with the elongated member between the two or more pins and the second end; and
a latch coupleable with the hook, the latch including:
a latch member having a central axis and a surface surrounding the central axis, the latch member having a first upper portion and second and third lower portions extending radially from the surface, the second and third lower portions circumferentially spaced from one another and axially spaced from the first upper portion, guide and limit surfaces of the second and third lower portions facing respective guide and limit surfaces of the first upper portion that cooperate to form first and second channels, the first and second channels being similarly shaped, each of the first and second channels having in order a first upwardly sloping path defined by a respective first upwardly slanting guide surface and a first limit surface of the first upper portion, a second downwardly sloping path defined by a respective second downwardly slanting guide surface and a second limit surface of a respective lower portion, and a third upwardly sloping path defined by a respective third upwardly slanting guide surface and a third limit surface of the first upper portion, the first and second channels configured to each receive one of the two or more pins of the hook; and
a lug nest located proximate the second limit surface of the first channel, the lug nest having a curved inner surface.

19. The pick-and-place system as recited in claim 19, wherein the two or more pins of the hook are located within the first and second channels of the latch.

20. The pick-and-place system as recited in claim 19, wherein one of the one or more elongated lugs is nested within the lug nest.

21. The pick-and-place system as recited in claim 19, wherein one of the one or more elongated lugs is sufficiently spaced from the one or more pins to prevent the one or more elongated lugs from fitting between the first upper portion and the second or third lower portions.

22. The pick-and-place system as recited in claim 19, wherein one of the one or more elongated lugs is spaced from the one or more pins by at least a maximum straight-line distance from the first limit surface to the second downwardly-sloping guide surface.
